(19) United States
(12) Patent Application Publication
(10) Pub. No.: US 2026/0062199 A1
(43) Pub. Date: Mar. 5, 2026

(54) AEROSOL DISPENSING DEVICES WITH AN IMPROVED SPRAY NOZZLE DESIGN

(71) Applicant: THE PROCTER & GAMBLE COMPANY, Cincinnati, OH (US)

(72) Inventors: Michael Anthony MAJHER, Cincinnati, OH (US); Nicholas Mark SAVASTANO, Londonderry, NH (US); Andrew William FRANCKHAUSER, Batavia, OH (US); Jason Joeseph MILLER, Blanchester, OH (US); Sean Michael RENOCK, Loveland, OH (US); Eric Edward SHELTON, Mason, OH (US)

(21) Appl. No.: 19/259,427

(22) Filed: Jul. 3, 2025

Related U.S. Application Data
(60) Provisional application No. 63/688,450, filed on Aug. 29, 2024.
(60) Provisional application No. 63/782,096, filed on Apr. 2, 2025.
(60) Provisional application No. 63/820,902, filed on Jun. 10, 2025.

(51) Int. Cl. B65D 83/44; A01N 25/06; A01N 27/00; A01N 31/06; A01N 35/06; A01N 37/40; A01N 65/06; A01N 65/08; A01N 65/22; A01N 65/24; A01N 65/28; A01N 65/44; A01P 13/00; A01P 15/00; B05B 1/02

(52) U.S. Cl. CPC B65D 83/44; A01N 25/06; A01N 27/00; A01N 31/06; A01N 35/06; A01N 37/40; A01N 65/06; A01N 65/08; A01N 65/22; A01N 65/24; A01N 65/28; A01N 65/44; A01P 13/00; A01P 15/00; B05B 1/02

(57) ABSTRACT

An aerosol dispensing device including an aerosol valve in fluid communication with a reservoir. A nozzle is in fluid communication with the aerosol valve. The nozzle includes a nozzle insert with an exit orifice and a nozzle body to receive the nozzle insert. The nozzle body is in fluid communication with the aerosol valve. A primary swirl chamber is in fluid communication with one or more inlet ports. The exit orifice is disposed generally concentric with the primary swirl chamber and a secondary swirl chamber and is in fluid communication therewith. The inlet port(s) are in fluid communication with the aerosol valve and may enter the primary swirl chamber non-tangentially. The secondary swirl chamber has a first and second diameter. A ratio of the first diameter to the second diameter is greater than about 1 and less than about 1.6. The pest control composition is non-Newtonian.

### CROSS REFERENCE TO RELATED APPLICATIONS

This application claims the benefit, under 35 U.S.C. § 119(e), to U.S. Provisional Application Nos. 63/688,450 filed Aug. 29, 2024; 63/782,096 filed Apr. 2, 2025; and 63/820,902, filed Jun. 10, 2025, the entire disclosure of which is fully incorporated by reference herein.

### FIELD OF THE INVENTION

The present disclosure relates generally to aerosol dispensers and more specifically to a spray nozzle design for an aerosol dispenser.

### BACKGROUND OF THE INVENTION

Water-based pest control compositions (such as herbicides or pesticides) containing essential oils and/or extracts, are available in the market today. However, these compositions are typically Newtonian with a viscosity of about 1 cP to about 7 cP and tend to drip off target surfaces after application. Thicker, non-Newtonian pest control compositions (e.g., compositions having a viscosity of at least 40 cP at a shear rate of 1 sec⁻¹ measured at 22° C. and a viscosity of from about 10 cP to about 50 cP at a shear rate of 500 sec⁻¹ measured at 22° C.) may stick to target surfaces better, but these fluids are challenging to spray through current aerosol dispensers because traditional nozzle designs deliver poor spray pattern and/or spray characteristics when dispensing these relatively thick fluids. For instance, when spraying such compositions through a traditional aerosol nozzle, the particle size of the sprayed product will be too big (e.g., having a Dv50 greater than about 225 microns), which can cause the product to splash upon impact and reach non-target surfaces. In addition, when spraying such compositions through a traditional aerosol nozzle, the spray rate and/or spray diameter may not be optimal (e.g., spray rate of less than about 3 g/s and/or a spray diameter of less than about 10 cm at a 12-inch spray distance) to reach a target surface when delivered from a standing position, resulting in insufficient coverage of the target surface.

A need, therefore, exists for an aerosol spray nozzle design for an aerosol dispensing device that is capable of delivering a non-Newtonian composition (e.g. a non-Newtonian water-based pest control composition) with spray characteristics capable of reaching the intended target (e.g., plants at ground level) when delivered from a standing position.

The discussion of shortcomings and needs existing in the field prior to the present disclosure is in no way an admission that such shortcomings and needs were recognized by those skilled in the art prior to the present disclosure.

### SUMMARY OF THE INVENTION

To solve the problems advanced above, the present disclosure provides methods and devices useful for delivering a non-Newtonian aerosol pest control composition with spray characteristics (e.g. spray rate, spray diameter, etc.) sufficient for the sprayed composition to reach an intended target (e.g. plants at ground level) when sprayed from a particular position (e.g. standing position).

It was recognized that spray nozzles in conventional aerosol dispensing devices typically feature inlet ports which direct the composition into a swirl chamber in a direction that is tangential to the outer wall of the swirl chamber. This is depicted in FIGS. 60 and 61, for example, which depict a direction 572 of fluid directed from the inlet ports into the swirl chamber that is tangential to the outer wall 518 of the swirl chamber. This is shown by the direction 572 being about parallel with the direction 570 that is tangential to the outer wall 518 of the swirl chamber in FIG. 60. Specifically, it was discovered that this tangential orientation of the inlet ports relative to the swirl chamber causes swirling of the fluid within the chamber and consequently the sprayed composition has a relatively small droplet size and relatively wide spray diameter, which may not sufficiently cover the target surface and be unacceptable to some consumers.

A unique nozzle geometry was developed to effectively spray a non-Newtonian composition such as a water-based pest control composition. Specifically, the unique nozzle design features inlet port(s) which enter a swirl chamber non-tangentially/orthogonal to the chamber wall. The inlet port(s) and swirl chamber of the improved nozzle design are configured to reduce and/or substantially eliminate fluid swirl in the swirl chamber. Additionally, the nozzle comprises a secondary swirl chamber having a decreasing tapered sidewall and an exit orifice having an increasing tapered sidewall. The inventive nozzle creates a spray rate which allows a non-Newtonian composition to be sprayed a sufficient distance (e.g., up to about 36 inches) to reach a target (e.g. target plant) and can create consumer preferable spray characteristics including, but not limited to, spray droplet size and/or spray diameter.

Disclosed herein is an aerosol pest control product comprising an aerosol dispensing device and a pest control composition. The aerosol dispensing device may comprise an aerosol container comprising a reservoir containing the pest control composition and a propellant; an aerosol valve in fluid communication with the reservoir; an actuator in operative communication with the aerosol valve, and a nozzle in fluid communication with the aerosol valve and configured to atomize the pest control composition. The nozzle may comprise a substantially cup-shaped nozzle insert comprising an exit orifice and a nozzle body for receiving and retaining the nozzle insert. The nozzle body may be in fluid communication with the aerosol valve and may comprise an insert post having an end surface. The nozzle may comprise a primary swirl chamber in fluid communication with one or more inlet ports and a secondary swirl chamber disposed between the exit orifice and the primary swirl chamber. The exit orifice may be disposed generally concentric with the primary and secondary swirl chambers and in fluid communication therewith. The one or more inlet ports may enter the primary swirl chamber non-tangentially and may be in fluid communication with the aerosol valve. The secondary swirl chamber may have a first diameter and a second diameter. The ratio of the first diameter to the second diameter may be greater than about 1 and less than about 1.6. The pest control composition may be non-Newtonian.

Also disclosed herein is an aerosol pest control product comprising an aerosol dispensing device and a pest control composition. The aerosol dispensing device may comprise an aerosol container comprising a reservoir containing the pest control composition and a propellant; an aerosol valve in fluid communication with the reservoir; an actuator in operative communication with the aerosol valve, and a nozzle in fluid communication with the aerosol valve and configured to atomize the pest control composition. The nozzle may comprise a substantially cup-shaped nozzle insert comprising an exit orifice and a nozzle body for receiving and retaining the nozzle insert. The nozzle body may be in fluid communication with the aerosol valve and may comprise an insert post having an end surface. The nozzle may comprise a primary swirl chamber in fluid communication with one or more inlet ports and a secondary swirl chamber disposed between the exit orifice and the primary swirl chamber. The exit orifice may be disposed generally concentric with the primary and secondary swirl chambers and in fluid communication therewith. The one or more inlet ports may be in fluid communication with the aerosol valve. A centerline of the one or more inlet ports may intersect a center point of the primary swirl chamber. The secondary swirl chamber may comprise a side wall extending in a decreasing taper towards the exit orifice. The exit orifice may comprise a side wall extending in an increasing taper from an entrance end adjacent the secondary swirl chamber to an opposing exit end. The pest control composition may exhibit a ratio of a first viscosity at a shear rate of 1 sec⁻¹ to a second viscosity at a shear rate of 500 sec⁻¹ measured at 22° C. of at least 1.5.

Also disclosed herein is an aerosol pest control product comprising an aerosol dispensing device and a pest control composition. The aerosol dispensing device may comprise an aerosol container comprising a reservoir containing the pest control composition and a propellant; an aerosol valve in fluid communication with the reservoir; an actuator in operative communication with the aerosol valve, and a nozzle in fluid communication with the aerosol valve and configured to atomize the pest control composition. The nozzle may comprise a substantially cup-shaped nozzle insert comprising an exit orifice and a nozzle body for receiving and retaining the nozzle insert. The nozzle body may be in fluid communication with the aerosol valve and may comprise an insert post having an end surface. The nozzle may comprise a primary swirl chamber in fluid communication with at least two opposing inlet ports and a secondary swirl chamber disposed between the exit orifice and the primary swirl chamber. The exit orifice may be disposed generally concentric with the primary and secondary swirl chambers and in fluid communication therewith. The at least two inlet ports may be in fluid communication with the aerosol valve. A fluid may be configured to flow from the first inlet port towards a center point of the primary swirl chamber in a first direction and flow from the second inlet port towards the center of the primary swirl chamber in a second direction. The first direction and the second direction may be at least partially aligned and intersect within the primary swirl chamber. Upon discharge from the nozzle, the pest control composition may exhibit a Dv50 value of from about 80 μm to about 200 μm as measured according to the Spray Droplet Size Test Method. The pest control composition may be non-Newtonian.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures, which provide non-limiting examples of various embodiments.

FIG. 1 is a front perspective view of an aerosol dispensing device.

FIG. 2 is a front view of an aerosol dispensing device in an unlocked configuration, resting on a support surface.

FIG. 3 is a front view of an aerosol dispensing device in a locked configuration.

FIG. 4 is a side view of an aerosol dispensing device.

FIG. 5 is a back view of an aerosol dispensing device.

FIG. 6 is a bottom view of an aerosol dispensing device.

FIG. 7 is a side perspective view of an aerosol dispensing device.

FIG. 8 is a partially exploded view of an aerosol dispensing device, showing an aerosol container and an undercap.

FIG. 9A is a front perspective view of an aerosol container with an aerosol stem displacing an aerosol valve to a closed position.

FIG. 9B is a front perspective view of an aerosol container with an aerosol stem displacing an aerosol valve to an open position.

FIG. 10 is a front, cross-sectional view along line A-A in FIG. 9A of an aerosol container comprising a valve and a dip tube, in an inverted orientation.

FIG. 11 is a front, cross-sectional view along line A-A in FIG. 9A of an aerosol container comprising a valve and a dip tube, in an upright orientation.

FIG. 12 is a top perspective view of an undercap.

FIG. 13 is a bottom perspective view of an undercap.

FIG. 14 is an exploded bottom perspective view of an undercap.

FIG. 15 is an exploded top perspective view of an undercap.

FIG. 16 is a side view of an undercap.

FIG. 17 is a back view of an undercap.

FIG. 18 is a cross-sectional view along line B-B in FIG. 16 of an undercap.

FIG. 19 is a cross-sectional view along line C-C in FIG. 17 of an undercap.

FIG. 20 is a cross-sectional view along line C-C in FIG. 17 of an undercap with the actuator lever 330 depressed.

FIG. 21 is a bottom perspective view of an aerosol dispensing device.

FIG. 22 is a bottom perspective view of an aerosol dispensing device with the actuator depressed.

FIG. 23 is an exploded side view of an actuator assembly having an improved nozzle design.

FIG. 24 is an exploded top perspective view of the actuator assembly in FIG. 23.

FIG. 25 is a cross-sectional view taken along line D-D in FIG. 26 of an actuator assembly.

FIG. 26 is a top view of the actuator assembly in FIG. 23.

FIGS. 27 and 28 are various views of a nozzle insert of the improved nozzle design in FIG. 23.

FIG. 29 is a cross-sectional view taken along line E-E in FIG. 30 of a nozzle insert.

FIG. 30 is a side view of the nozzle insert in FIGS. 27 and 28.

FIG. 31 is a cross-sectional view taken along line E-E in FIG. 30 of a nozzle insert.

FIG. 32 is a perspective view of a nozzle insert of the improved nozzle design in FIG. 23.

FIG. 33 is a cross-sectional view taken along line F-F in FIG. 34 of an actuator assembly with the nozzle insert removed.

FIG. 34 is a top view of the actuator assembly of FIG. 26 with the nozzle insert removed.

FIGS. 35 and 36 are various views of the nozzle body of the actuator assembly of FIG. 33.

FIG. 37 is a cross-sectional view taken along line G-G in FIG. 38 of the nozzle body of the actuator assembly.

FIG. 38 is a top view of the nozzle body of the actuator assembly of FIG. 33.

FIGS. 39 and 40 are various views of the improved nozzle design.

FIG. 41 is a cross-sectional view taken along line H-H in FIG. 42 of the improved nozzle design.

FIG. 42 is a top view of the improved nozzle design.

FIG. 43 is a partial cross-sectional view taken along line H-H in FIG. 42 of the improved nozzle design.

FIGS. 44 through 59 are various partial views of different insert post designs for the improved nozzle described herein).

FIGS. 60 and 61 are various partial views of a conventional nozzle design for a conventional aerosol dispensing device.

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Non-tangential” may generally refer to a direction of an inlet port intersecting a swirl chamber such that both a leading side and trailing side of the inlet port intersecting the swirl chamber form a corner with an outer wall of the swirl chamber.

“Non-tangential” may also generally refer to a direction of an inlet port intersecting a swirl chamber where a first angle is formed between a leading side of the inlet port and a direction tangent to an outer wall of the swirl chamber intersecting the leading side, a second angle is formed between a trailing side of the inlet port and a direction tangent to the outer wall of the swirl chamber intersecting the trailing side and where the ratio between the first and second angle is in a preferred range (e.g. between about 1 to less than about 2).

“Non-tangential” may also generally refer to a direction of each of a multiple number of inlet ports intersecting a swirl chamber such that a centerline of each of the multiple number of inlet ports are at least partially aligned and intersect at a point within the swirl chamber (e.g. center point).

“Corner” means an intersection between two surfaces, where an angle defined between the two surfaces at the intersection is in a range of about 90 degrees±50 degrees.

“Standard temperature and pressure” generally refers to 25° C. and 1 atmosphere. Standard temperature and pressure may also be referred to as “ambient conditions.” Unless indicated otherwise, parts are by weight, temperature is in ° C., and pressure is at or near atmospheric.

“Disposed on” refers to a positional state indicating that one object or material is arranged in a position adjacent to the position of another object or material. The term does not require or exclude the presence of intervening objects, materials, or layers.

“Disposed within” refers to a positional state indicating that one object or material is arranged in a position partially or completely surrounded by another object or material. The term does not require or exclude the presence of intervening objects, materials, or layers.

“Align” or “aligned” or “aligning” between two or more inlet ports intersecting a swirl chamber means that a centerline of each of the two or more inlet ports intersect within the swirl chamber at a non-orthogonal angle such that the centerline of each of the two or more inlet ports has a non-zero component oriented along a same direction.

“Longitudinal axis” refers to an imaginary line running down the center of a body along its longest dimension.

“Direction of gravity” refers to the orientation or path along which gravity acts on an object or in a given space.

“Downward direction” refers to a direction that is substantially in or aligned with the direction of gravity.

“Upward direction” refers to a direction that is substantially opposed to the direction of gravity.

“Upright orientation” refers to a position or an alignment of an aerosol dispensing device in which the device dispenses an aerosol spray in an upward direction.

“Inverted orientation” refers to a position or an alignment of an aerosol dispensing device in which the device dispenses an aerosol spray in a downward direction.

“Multidirectional” refers to the ability of the device to dispense its contents effectively in various orientations. This includes not only an upright position, an inverted position but also sideways, or at any other angle, without noticeable loss of performance or function. This feature ensures consistent spray output regardless of the device's alignment, providing greater flexibility, targeting accuracy, and convenience to the user.

“Above” refers to a relative position of a first object or a first portion of an object in reference to a second object or a second portion of an object, in which a line extending from the first object toward the second object or from the first portion toward the second portion extends in a downward direction. In such an orientation, the first object is above the second object.

“Below” refers to a relative position of a first object or a first portion of an object in reference to a second object or a second portion of an object, in which a line extending from the first object toward the second object or from the first portion toward the second portion extends in an upward direction. In such an orientation, the first object is below the second object.

“Distal” is used to describe a location or position that is situated farther away from a point of reference or origin.

“Proximal” is used to describe a location or position that is situated closer to a point of reference or origin.

“Top” refers to a portion of an aerosol dispensing device or a component thereof that is distal to a point at which the aerosol spray exists the device. The term “top” is, therefore, most clear when the aerosol dispensing device is in an inverted orientation. Thus, the term “top” as used herein may be replaced with the term “distal” as helpful to improve clarity.

“Bottom” refers to a portion of an aerosol dispensing device or a component thereof that is proximal to a point at which the aerosol spray exists the device. The term “bottom” is, therefore, most clear when the aerosol dispensing device is in an inverted orientation. Thus, the term “bottom” as used herein may be replaced with the term “proximal” as helpful to improve clarity.

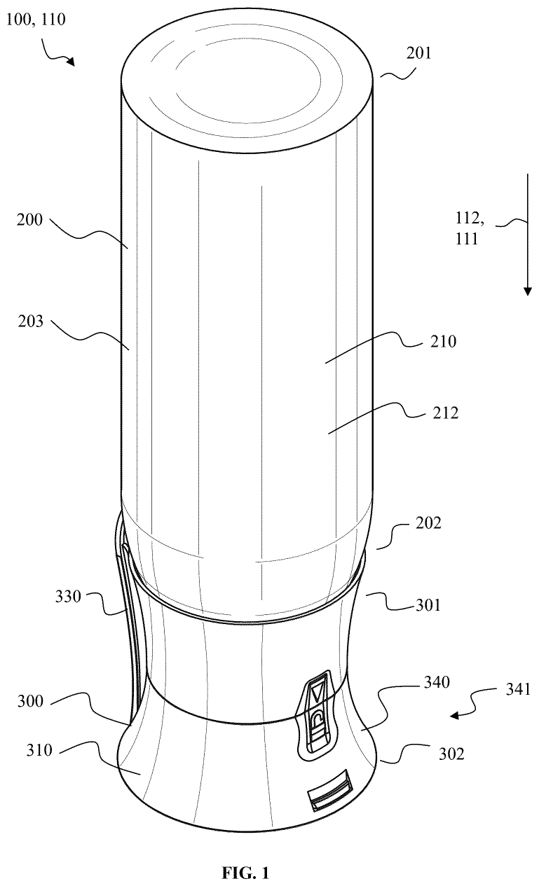

FIG. 1-FIG. 8 cooperate to illustrate various views of an aerosol dispensing device 100. FIG. 1 provides a front perspective view of the aerosol dispensing device 100, which may comprise an aerosol container 200 and an undercap 300. The aerosol container 200 may be aligned with and may cooperatively engage the undercap 300. The aerosol container may have a top portion 201 and a bottom portion 202. The undercap 300 may have a top portion 301 and a bottom portion 302 with a sidewall 310 extending therebetween. The sidewall 310 may be concave and the narrowest portion of the undercap 300 may be positioned at a junction of the top portion 301 and the bottom portion 302. The bottom portion 202 of the aerosol container 200 may be adjacent to and may cooperatively engage the top portion 301 of the undercap 300. A composition 210, such as a pest control composition, and a propellant 212 may be disposed within the aerosol container 200. The aerosol dispensing device 100 may be in an inverted orientation 110, such that it is positioned to dispense an aerosol spray comprising the composition 210 in a generally downward direction 111 that substantially aligns with a direction of gravity 112.

The aerosol container 200 comprises a wall 203. The wall 203 may comprise a plastic material or a metal. Exemplary plastic material can include polymeric and may be partially, substantially, or entirely comprised of polyester; polyethyleneterephthalate (“PET”); polyethylene napthalate, polyethylene furanoate, polyamide; nylon; polycarbonate; polyoxymethylene; polyacrylonitrile; polyolefin; polyethylene, polypropylene, fluoropolymer; poly(butylene succinate); virgin, recycled, and regrind versions of the other polymer materials; bio-based and petroleum-based versions of the other polymer materials; and mixtures thereof. The plastic container may comprise multiple layers of other polymer materials. The aerosol container 200 may be transparent or translucent.

The propellant may be a compressed gas propellant and/or a liquified propellant. Examples of compressed gases can include air, argon, nitrogen, nitrous oxide, inert gases, and carbon dioxide. Examples of liquefied propellants can include propane, isobutane, n-butane, isopentane, n-pentane, hydrofluoroolefins, and dimethyl ether. In some aspects, the propellent may be selected from carbon dioxide, nitrogen, or mixtures thereof. The propellent may be non-flammable. Along with the particular type of gas, the amount of headspace provided by the gas can be adjusted or tailored as desired. Because compressed gases do not significantly dissolve in the liquid portion of a compressed gas product, the amount of headspace is primarily a function of the amount of compressed gas used in the container. A headspace of about 10% to about 50%, or about 30% to about 40%, may be used. Alternatively, the headspace may be less than about 30%, or greater than about 40%.

At 21° C., the aerosol container 200 may be pressurized to an internal gage pressure of about 170 kPa to about 1150 kPa, or from about 350 kPa to about 1050 kPa, or from about 500 kPa to about 900 kPa using a propellant. The aerosol container 200 may have an initial internal gage pressure at 21° C. of from about 800 kPa to about 1150 kPa and a final internal gage pressure at 21° C. of from about 170 kPa to about 245 kPa. The volumetric ratio of composition to propellant may be from about 90/10 to about 50/50, or from about 40/60 to about 70/30, or from about 50/50 to about 60/40.

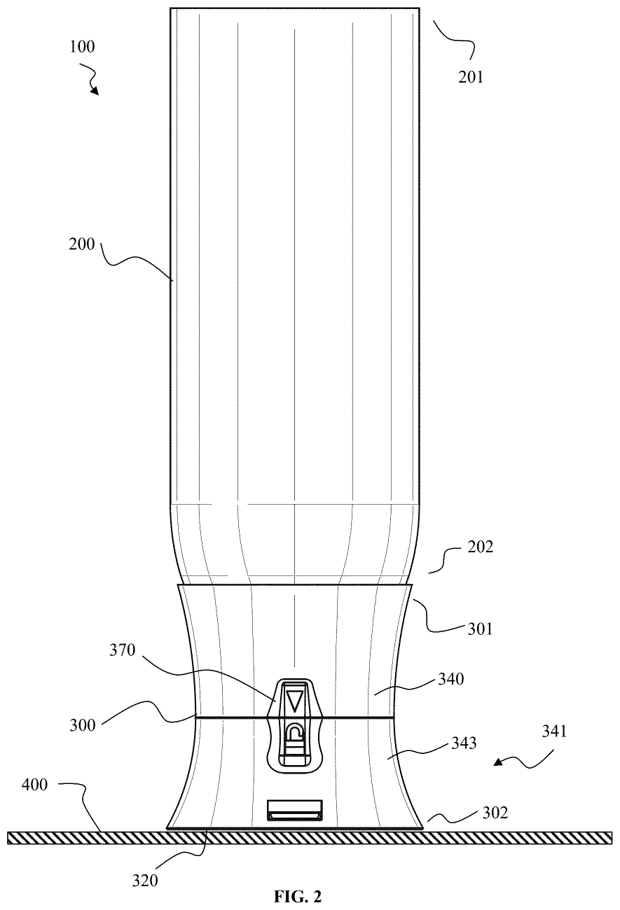

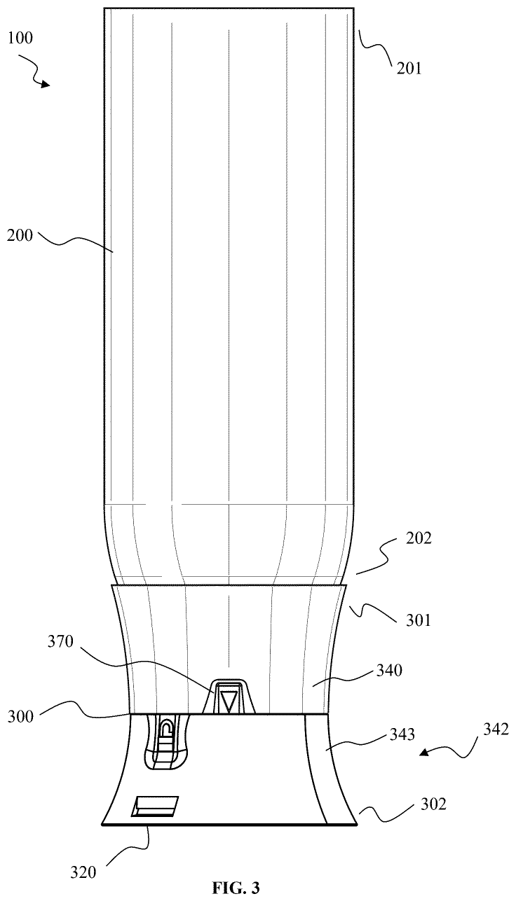

FIG. 2 provides a front view with the aerosol dispensing device 100 in an unlocked configuration, resting on a support surface 400 and FIG. 3 provides a front view of an aerosol dispensing device 100 in a locked configuration. In the unlocked configuration, a rotatable portion 340, which may correspond with a top portion 301, of the undercap 300 is in a first rotational position 341 relative to a fixed portion 343, to allow spray to be dispensed from the aerosol dispensing device 100. In the locked configuration, the rotatable portion 340 may be in a second rotational position 342 to prohibit spray to be dispensed from the aerosol dispensing device 100. Allowing or prohibiting spray may be accomplished, for example, by hindering movement of an actuator lever 330, described hereinafter. An indicator 370 may provide a notification to a user as to whether the device 100 is in a locked or an unlocked configuration. As shown in FIG. 2, the aerosol dispensing device 100 is resting on a supporting surface 400. More specifically, a base surface 320 of the undercap 300 is disposed on the supporting surface 400. It is to be appreciated that although the top portion 301 of the undercap 300 is shown as being rotatable relative to a fixed bottom portion 302, the bottom portion 302 of the undercap 300 may be rotatable relative to a fixed top portion 301.

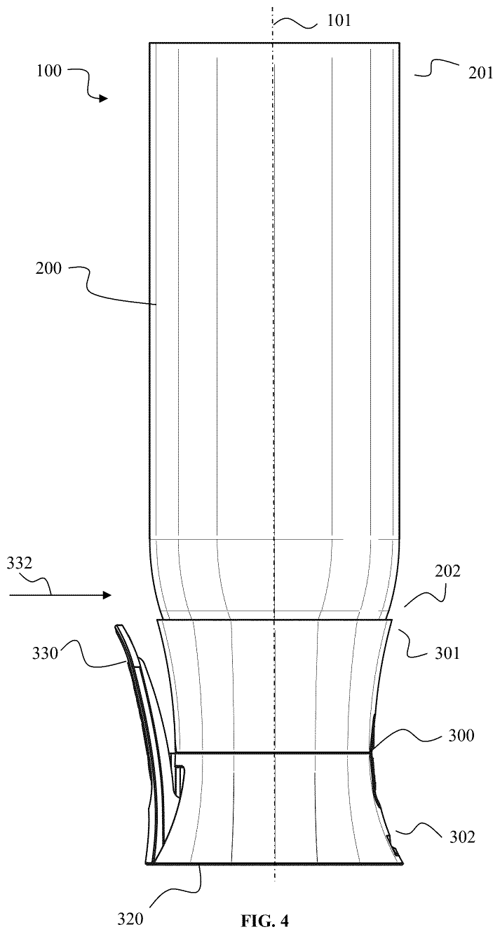

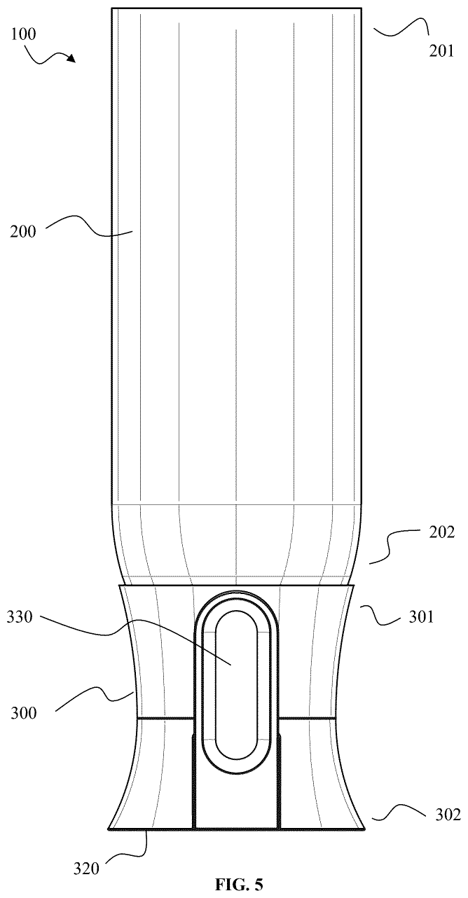

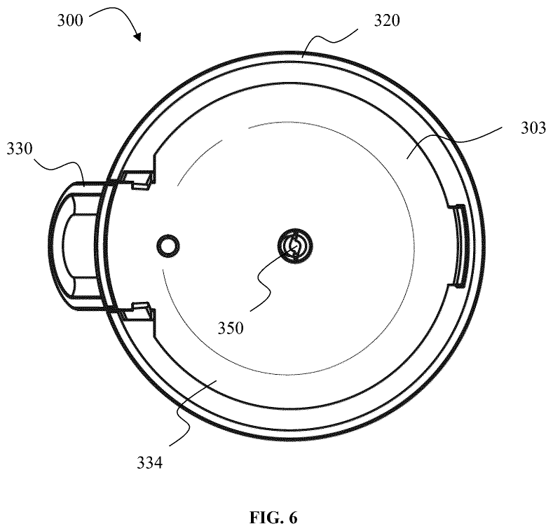

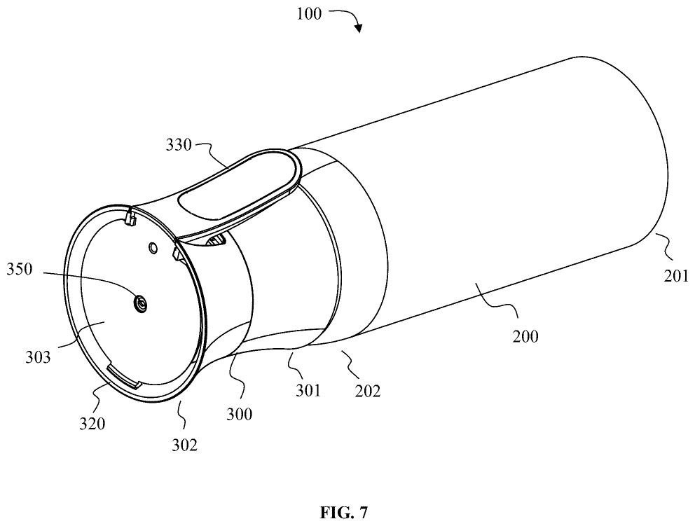

FIG. 4 provides a side view, FIG. 5 provides a back view, FIG. 6 provides a bottom view of an aerosol dispensing device 100, and FIG. 7 provides a side perspective view. The undercap 300 may comprise an actuator assembly 303, described hereinafter, comprising an actuator lever 330 which may be depressed in a direction 332 toward a longitudinal axis 101 of the device 100. The actuator assembly 303 may further comprise a through-hole 350 through which an aerosol spray may be dispensed. The through-hole 350 may be defined in a bottom surface 334 of the actuator of the actuator assembly 303.

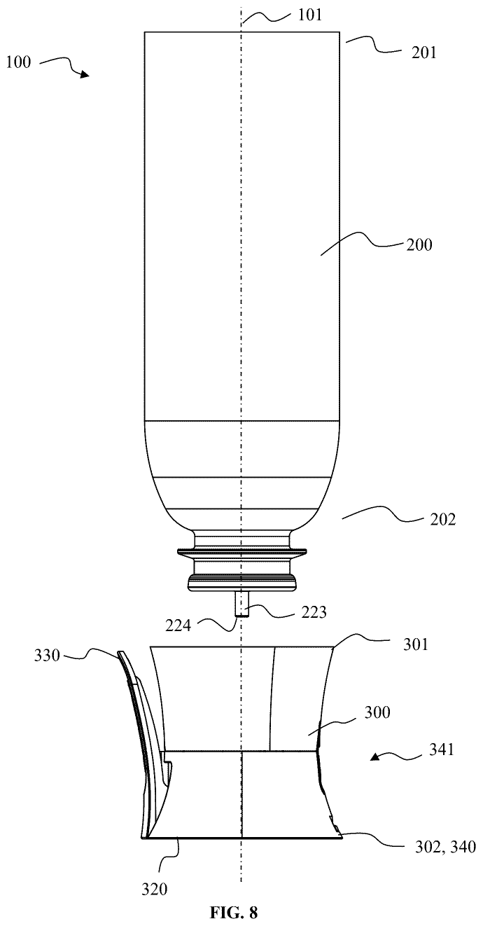

FIG. 8 provides a partially exploded view of an aerosol dispensing device 100, showing an aerosol container 200 and an undercap 300. As shown, in FIG. 8, the aerosol container 200 may comprise a valve stem 223, which may be aligned with the longitudinal axis 101 of the device 100 and which may be disposed within the undercap 300 to cooperatively engage a stem engaging channel 360 thereof (See: FIG. 15). The valve stem 223 may also comprise an exit orifice 224. The exit orifice 224 of the valve stem 223 may be substantially parallel to the base surface 320 of the bottom portion 302 of the undercap 300 when the device 100 is not dispensing any aerosol spray, which may correspond to a non-actuated state of the actuator lever 330.

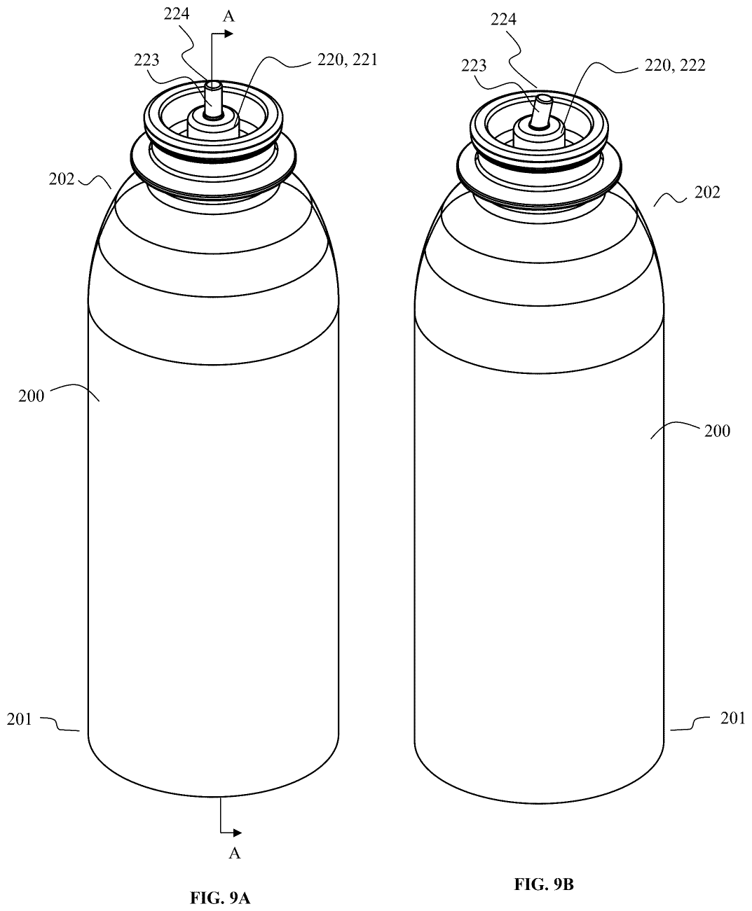

FIG. 9A-FIG. 13 cooperate to illustrate various views of an aerosol container 200. FIG. 9A is a front perspective view of an aerosol container 200 with an aerosol stem 223 displacing an aerosol valve 220 to a closed position 221. FIG. 9B is a front perspective view of an aerosol container 200 with an aerosol stem 223 displacing an aerosol valve 220 to an open position 222. In both figures, the aerosol container 200 is shown in an upright orientation. The aerosol container 200 may have a top portion 201 and a bottom portion 202. At or adjacent to the bottom portion 202, the aerosol container 200 may comprise an aerosol valve 220 and a valve stem 223. The valve stem 223 may displace the aerosol valve 220 between a closed position 221 and an open position 222. When the valve stem 223 displaces the aerosol valve 220 to the open position 222, the exit orifice 224 of the valve stem 223 may be from about 3 degrees to about 10 degrees, or from about 4 degrees to about 9 degrees, or from about 5 degrees to about 8 degrees, or from about 5.5 degrees to about 7.5 degrees, or from about 6 degrees to about 7 degrees out of plane with respect to the base surface 320 of the bottom portion 302 of the undercap 300. The valve stem 223 may preferably be biased towards the actuator lever 330.

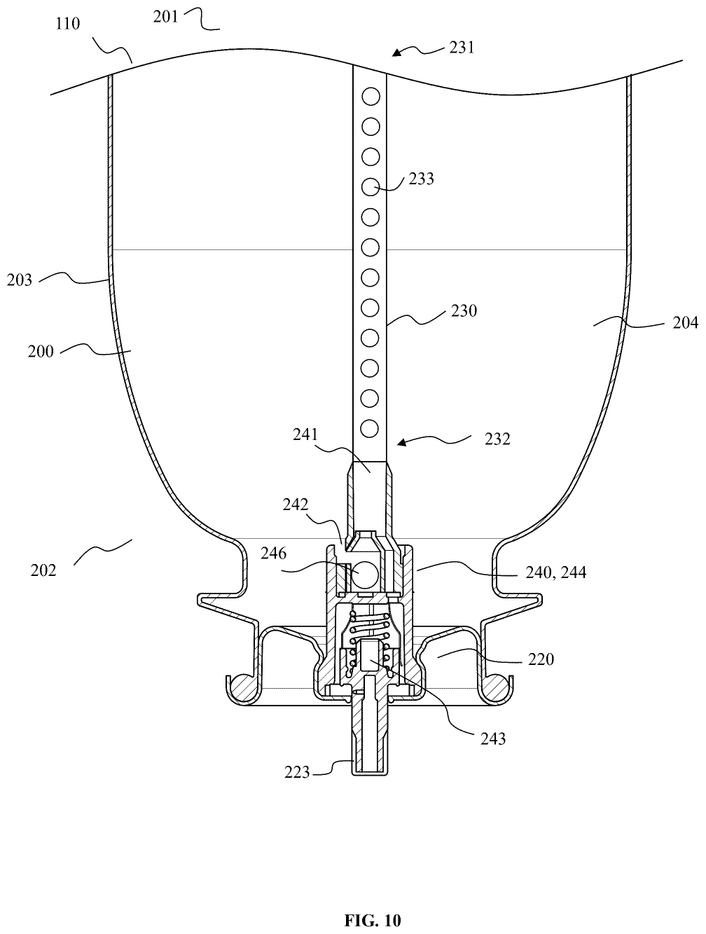

FIG. 10 is a front, cross-sectional view along line A-A in FIG. 9A of an aerosol container comprising a valve 240 and a dip tube 230, in an inverted orientation 110. FIG. 11 is a front, cross-sectional view along line A-A in FIG. 9A of an aerosol container comprising a valve 240 and a dip tube 230, in an upright orientation 109. The dip tube 230 may comprise a first end 231 extending to and in fluid communication with the top portion 201 of the aerosol container 200. The dip tube 230 may also comprise a second end 232 extending to the bottom portion 202 of the aerosol container 200. In some configurations, the dip tube 230 may comprise a continuous wall devoid of openings, such as perforations, other than at the first end 231 and the second end 232. In some configurations, the dip tube 230 may comprise a plurality of perforations 233. Generally, a dip tube 230 without perforations 233 may be employed in association with a valve 240 and a dip tube 230 with perforations 233 may be employed without a valve 240, but any combination of these features may be employed. The valve 240 may comprise first inlet 241 in fluid communication with the second end 232 of the dip tube 230. The valve 240 may also comprise second inlet 242 in fluid communication with aerosol container 200. The aerosol container 200 may comprise a wall 203 that defines an interior reservoir 204. The interior reservoir 204 defined by wall 203 may include a composition and a propellant (e.g. pressure in a range from about 30 psi to about 130 psi). The valve 240 may also comprise an outlet 243 in fluid communication with the aerosol valve 220. In some aspects, valve 240 may be a check valve, a slotted valve, a bag on valve, or the like. In some aspects, the valve 240 may comprise a ball 246. When the device 100, and thereby the aerosol container 200, is in an inverted orientation 110, the ball 246 may be in a first position 244 blocking flow through the first inlet 241 and allowing flow through the second inlet 242. When the device 100, and thereby the aerosol container 200, is in an upright orientation 109, the ball 246 may be in a second position 245 blocking flow through the second inlet 242 and allowing flow through the first inlet 241.

### FIG. 12-FIG. 20 Cooperate to Illustrate Various Views of an Undercap 300.

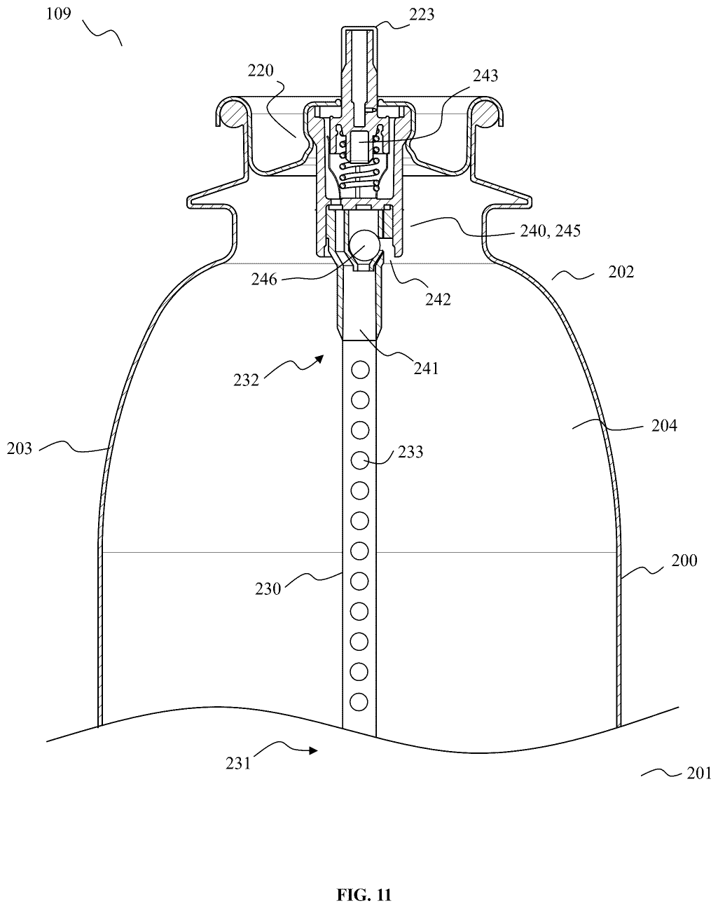

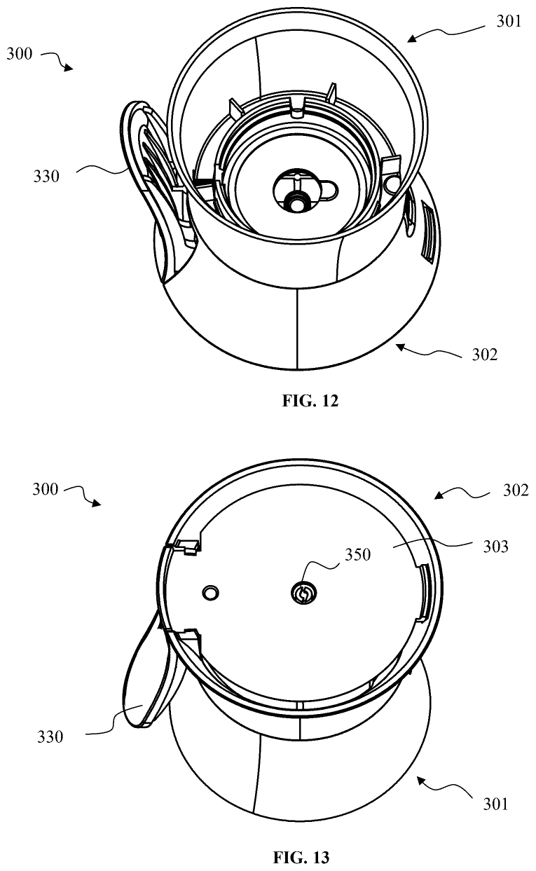

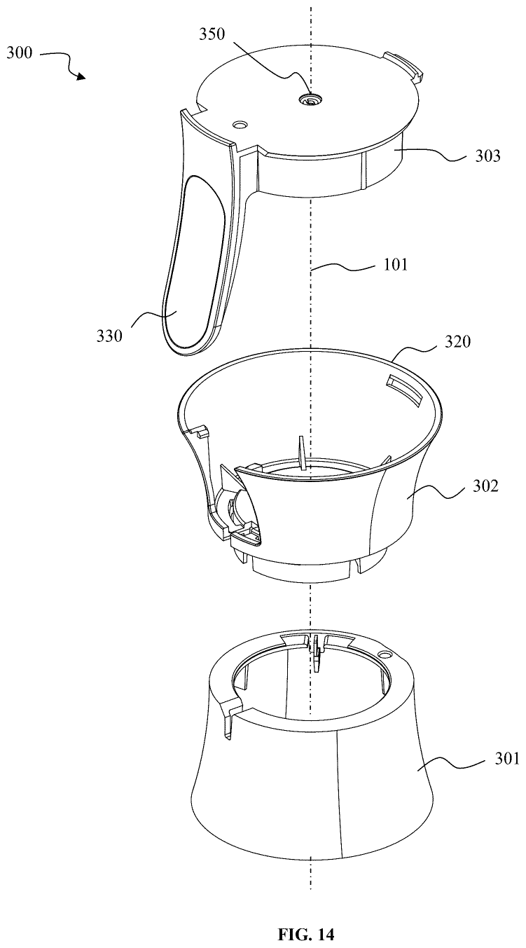

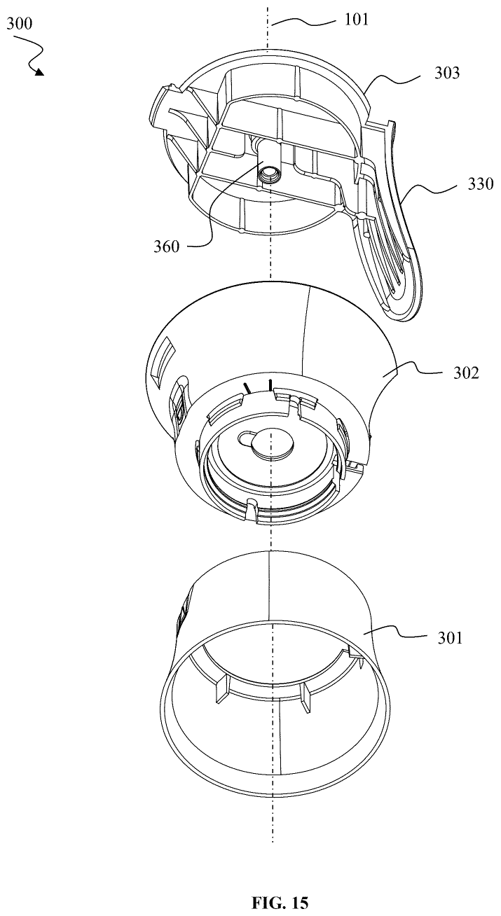

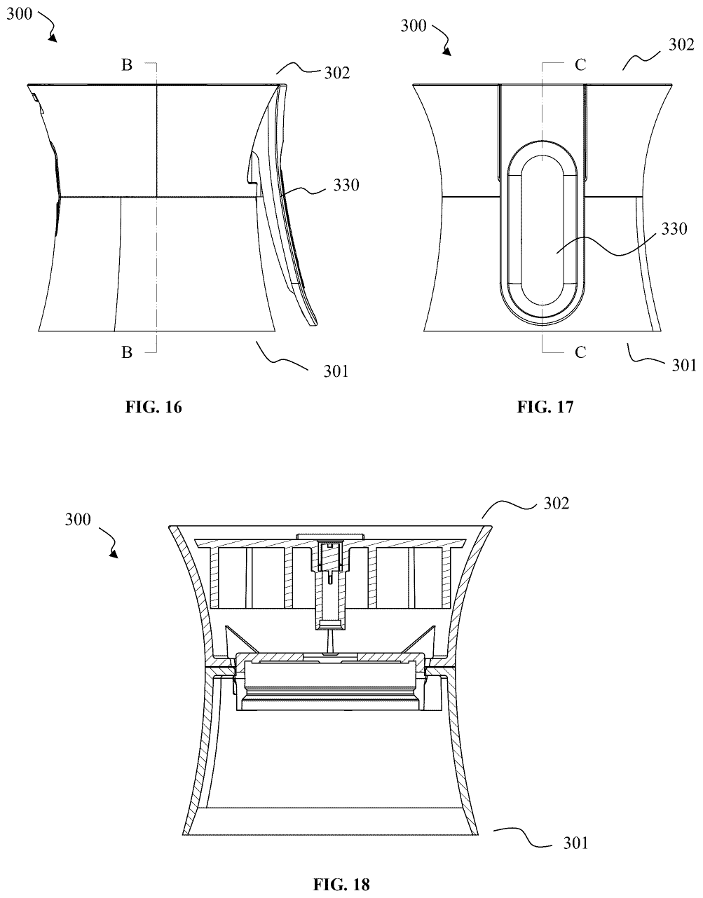

FIG. 12 provides a top perspective view, FIG. 13 provides a bottom perspective view of an undercap 300, FIG. 14 provides an exploded bottom perspective view, FIG. 15 provides an exploded top perspective view, FIG. 16 provides a side view, and FIG. 17 provides a back view of an undercap 300. The undercap 300 may comprise an actuator assembly 303 comprising an actuator lever 330. Actuator assembly 303 may include a stem-engaging channel 360 that may be aligned with the longitudinal axis 101 and may be configured to engage the valve stem 223 of an aerosol container 200 when the device 100 is fully assembled. Actuation of the actuator lever 330 to displace the valve stem 223 as shown in FIG. 9B causes the valve stem 223 to displace the aerosol valve 220 between a closed position 221 and an open position 222. FIG. 18 is a cross-sectional view along line B-B in FIG. 16 view of an undercap 300.

FIG. 19 is a cross-sectional view along line C-C in FIG. 17 of an undercap 300 with the actuator lever 330 in a non-actuated state. When the actuator lever 330 is in a non-actuated state, the actuator lever 330 does not displace the valve stem 223, the valve stem 223 does not displace the aerosol valve 220 (the aerosol valve 220 is in the closed position 221), and the exit orifice 224 of the valve stem 220 may be substantially parallel to the base surface 320 of the bottom portion 302 of the actuator assembly 303.

FIG. 20 is a cross-sectional view along line C-C in FIG. 17 of an undercap 300 with the actuator lever 330 depressed. When the actuator lever 330 displaces the valve stem 223 and the valve stem 223 displaces the aerosol valve 220 to the open position 222 the exit orifice 224 of the valve stem 223 may be at an angle 226 of about 3 degrees to about 10 degrees, or from about 4 degrees to about 9 degrees, or from about 5 degrees to about 8 degrees, or from about 5.5 degrees to about 7.5 degrees, or from about 6 degrees to about 7 degrees out of plane with respect to the base surface 320 of the bottom portion 302 of the actuator assembly 303. In some configurations, the angle 226 may be about 0 degrees. For convenience, the angle 226 is shown between a plane 321 aligned with the bottom surface 320 and a plane 225 aligned with the exit orifice 224.

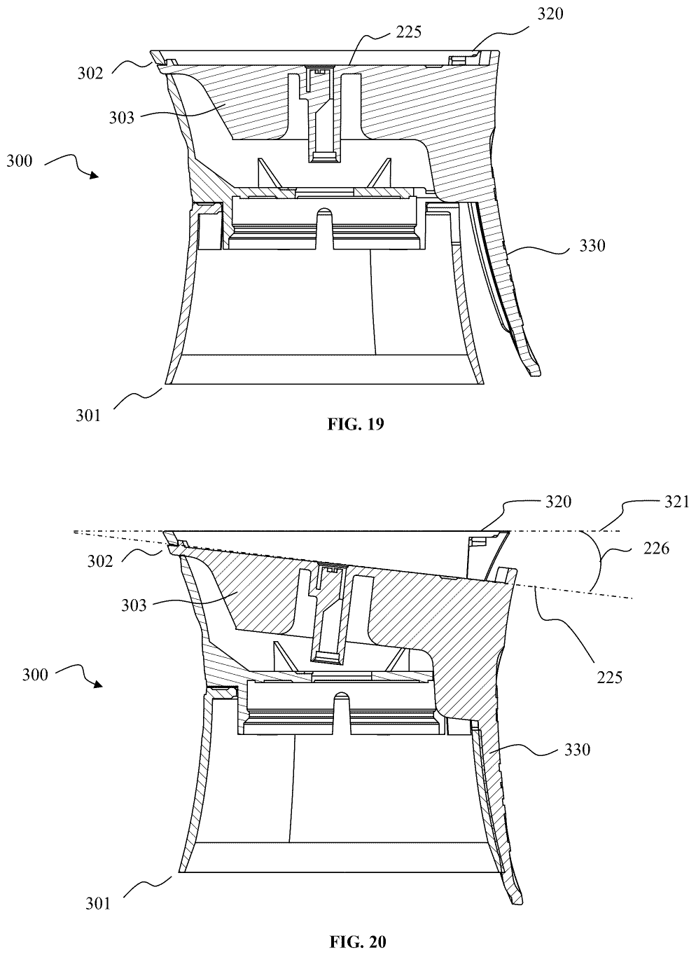

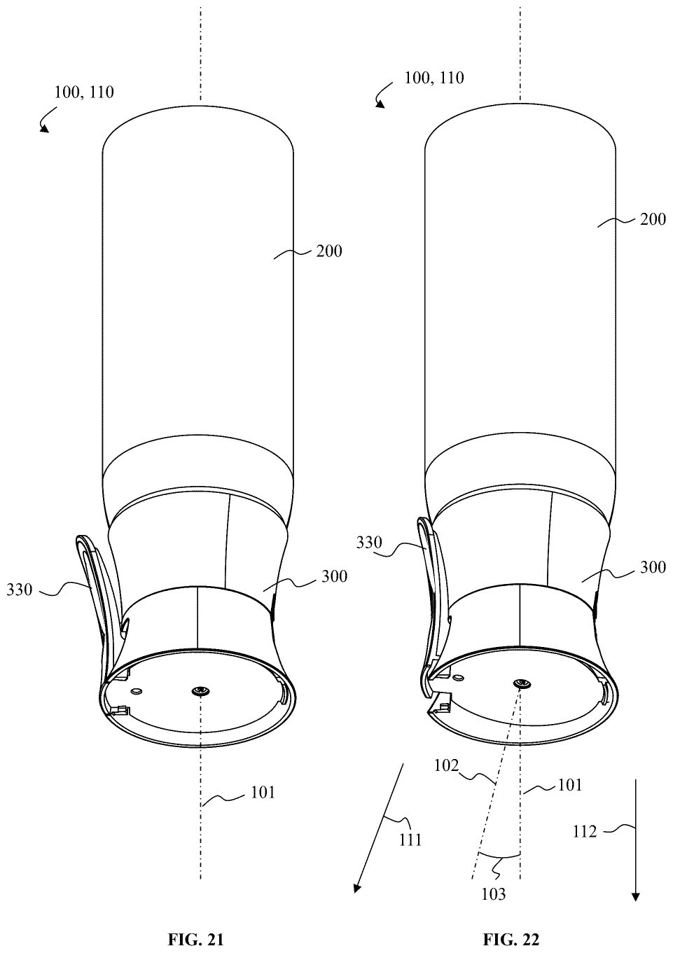

FIG. 21 and FIG. 22 cooperate to illustrate a dispensing angle 103 of the device 100 in an inverted orientation 110. FIG. 21 is a bottom perspective view and FIG. 22 is a bottom perspective view of an aerosol dispensing device 100 with the actuator lever 330 depressed. The device 100 may dispense an aerosol spray comprising the composition 210 in a generally downward direction 111 substantially along a spray axis 102. The spray axis 102 may be at an angle 103 relative to the longitudinal axis 101 of the device 100. The angle 103 may be about 3 degrees to about 10 degrees, or from about 4 degrees to about 9 degrees, or from about 5 degrees to about 8 degrees, or from about 5.5 degrees to about 7.5 degrees, or from about 6 degrees to about 7 degrees. In some configurations, the angle 103 may be about 0 degrees.

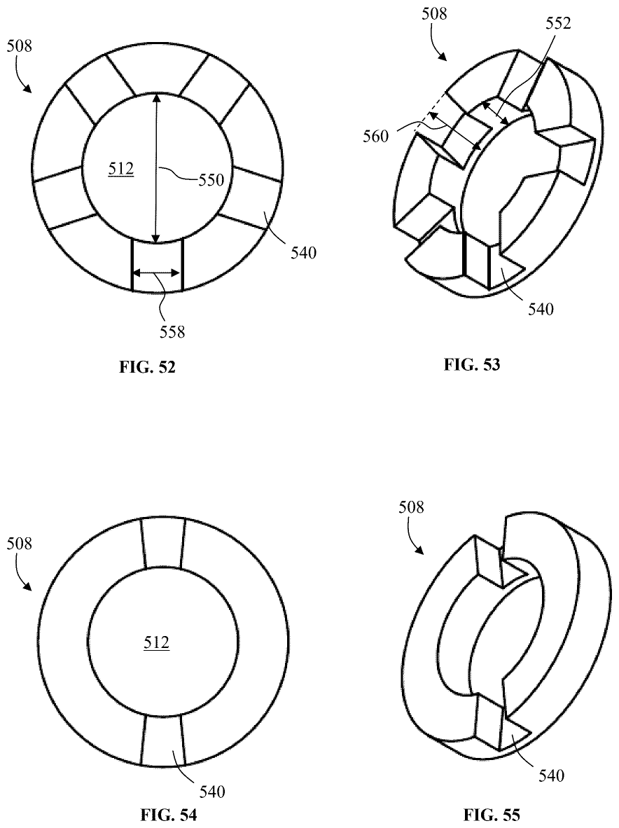

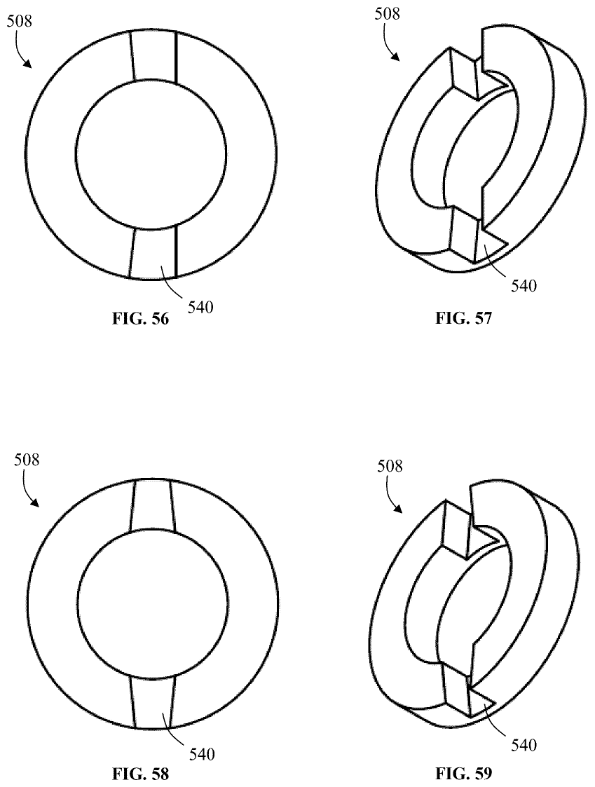

FIG. 23-FIG. 59 Cooperate to Illustrate Various Views of an Actuator Assembly 303′ with an Improved Nozzle Design

FIG. 23 is an exploded side view of an actuator assembly 303′ and an improved nozzle design. FIG. 24 is an exploded top perspective view of the improved nozzle design in FIG. 23 of the actuator assembly 303′. FIG. 25 is a cross-sectional view taken along line D-D in FIG. 26 of the actuator assembly 303′. FIG. 26 is a top view of the actuator assembly in FIG. 23. The actuator assembly 303′ may share similar features and may operate in a similar manner as the actuator assembly 303 previously discussed, with the exception of the features of the actuator assembly 303′ discussed herein.

The actuator assembly 303′ may include a nozzle 500 in fluid communication with the aerosol valve 220. The nozzle 500 may be configured to atomize the pest control composition.

The nozzle 500 may include a nozzle insert 502 having an exit orifice 504. The nozzle insert 502 may be a substantially cup-shaped nozzle insert having the exit orifice 504. As further shown in FIG. 25, the nozzle 500 may also include a nozzle body 506 for receiving and retaining the nozzle insert 502. In some configurations, the nozzle body 506 may be integral with the actuator assembly. In some configurations, a frictional interference fit may be used between the nozzle insert 502 and the wall of the nozzle body 506. However, in other configurations, other means may be used for connecting the nozzle insert 502 with the nozzle body 506, such as a threaded or snap fit. Although FIGS. 23 through 26 depict that the improved nozzle 500 design may include the nozzle insert 502 and the nozzle body 506, in other configurations the nozzle 500 may not feature a separate nozzle insert 502 and nozzle body 506 but instead may feature a single integral piece with dimensions and characteristics similar to when the nozzle insert 502 is received within the nozzle body 506. For example, such as integrated nozzle 500 design may be manufactured using such processes as 3D printing.

The improved nozzle design disclosed herein may achieve one or more desired spray characteristics of the pest control composition from the aerosol dispensing device featuring the actuator assembly 303′. In some aspects, a desired spray characteristic may be a Dv10 droplet size of the sprayed pest control composition. Upon discharge from the nozzle, the pest control composition may exhibit a Dv10 value of from about 55 μm to about 105 μm, or from about 60 μm to about 95 μm, as measured according to the Spray Droplet Size Test Method.

In some aspects, a desired spray characteristic may be a Dv50 droplet size of the sprayed pest control composition. Upon discharge from the nozzle, the pest control composition may exhibit a Dv50 value of from about 80 μm to about 200 μm, or from about 90 μm to about 180 μm, or from about 100 μm to about 150 μm, as measured according to the Spray Droplet Size Test Method.

In some aspects, a desired spray characteristic may be a Dv90 droplet size of the sprayed pest control composition. Upon discharge from the nozzle, the pest control composition may exhibit a Dv90 value of from about 100 μm to about 600 μm, or from about 150 μm to about 500 μm, or from about 200 μm to about 350 μm, as measured according to the Spray Droplet Size Test Method.

In some aspects, a desired spray characteristic may be a D[3][2] (or Sauter Mean) droplet size of the sprayed pest control composition. Upon discharge from the nozzle, the pest control composition may exhibit a D[3][2] value of from about 80 μm to about 180 μm, or from about 85 μm to about 150 μm, or from about 90 μm to about 125 μm, as measured according to the Spray Droplet Size Test Method.

In some aspects, a desired spray characteristic may be a spray diameter of the pest control composition upon discharge from the nozzle 500. The spray diameter of the pest control composition upon discharge from the nozzle may be in a range from about 10 cm to about 21 cm, or from about 13 cm to about 18 cm, as measured according to the Spray Diameter Method.

In some aspects, a desired spray characteristic may be a spray rate of the pest control composition upon discharge from the nozzle 500. The spray rate of the pest control composition upon discharge from the nozzle may be from about 3 g/s to about 6 g/s, or from about 3.5 g/s to about 5 g/s, as measured according to the Spray Rate Method.

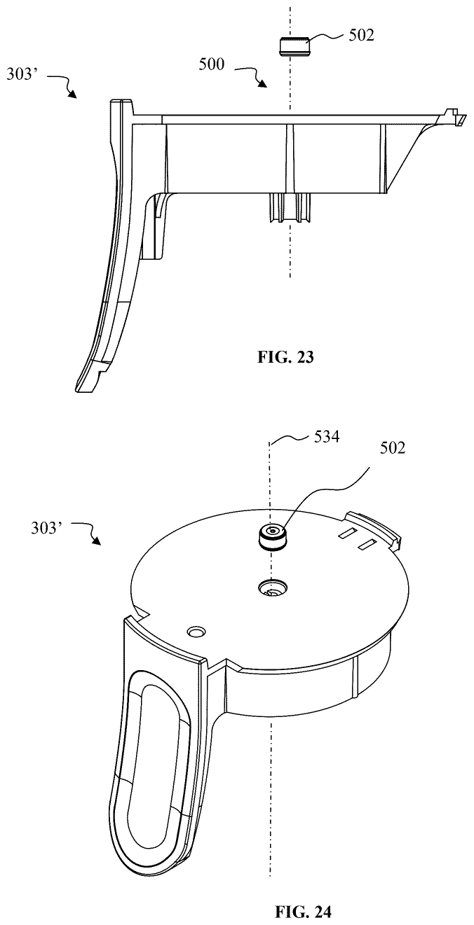

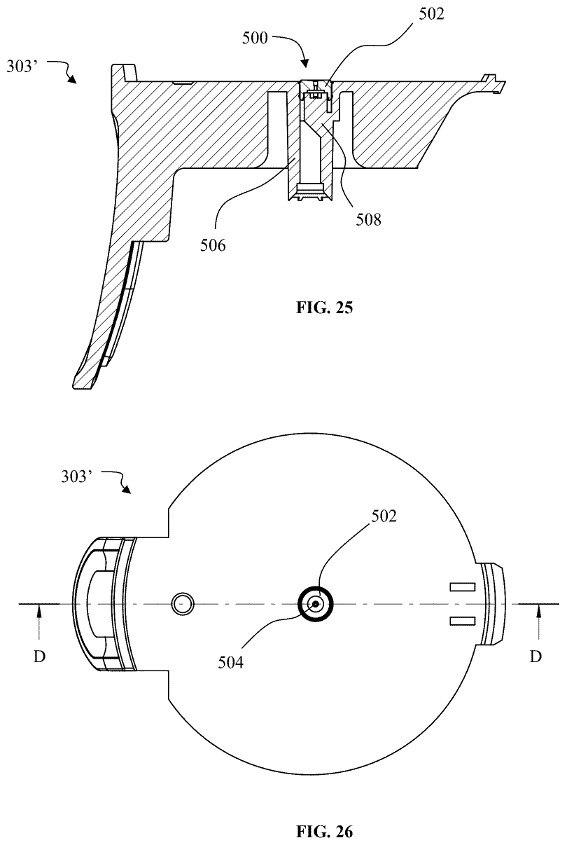

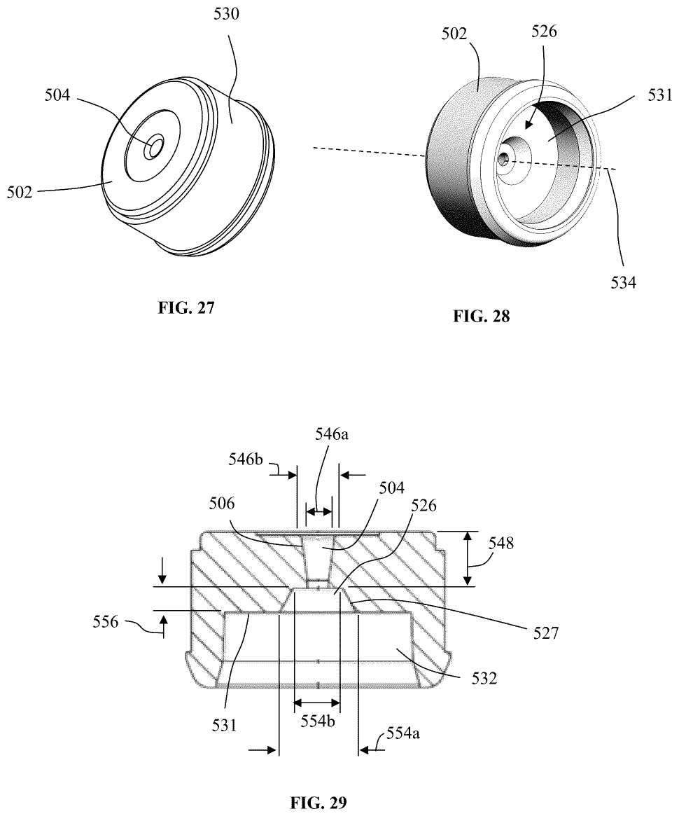

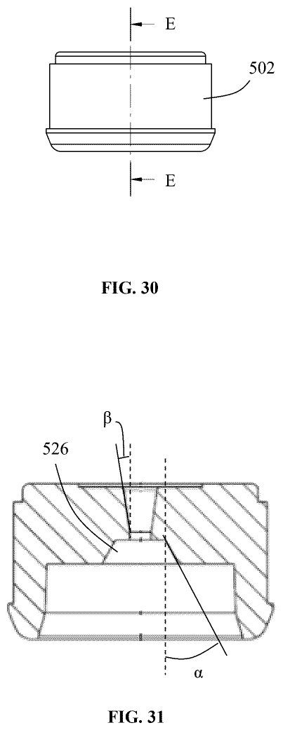

The nozzle insert 502 of the improved nozzle 500 design will now be discussed. FIGS. 27 and 28 are various views of the nozzle insert 502 of the improved nozzle 500 design in FIG. 23. As shown in FIGS. 27 and 28, the nozzle insert 502 may feature an outer surface 530. Similarly, as shown in FIGS. 28 and 29, the nozzle insert 502 may feature a cavity 532 extending along a longitudinal axis 534 of the nozzle insert 502 to an end face 531. FIGS. 29 and 31 are cross-sectional views taken along line E-E in FIG. 30 of the nozzle insert 502. FIG. 30 is a side view of the nozzle insert 502 in FIGS. 27 and 28. As shown in FIGS. 28 and 29, the nozzle insert 502 may feature a secondary swirl chamber 526 disposed generally concentric with the exit orifice 504. The secondary swirl chamber 526 may have a secondary swirl chamber volume of from about 1.5 mm³ to about 2.5 mm³, or from about 1.8 mm³ to about 2 mm³. One advantage of the secondary swirl chamber 526 may be to help reduce the velocity of fluid flow before the fluid exits the nozzle 500.

Secondary swirl chamber 526 may have a side wall 527 that extends from end face 531 towards the exit orifice in a continuous decreasing taper such that the diameter of the secondary swirl chamber 526 decreases from adjacent to the end face to the exit orifice. This is in contrast to traditional swirl chambers which may comprise a sidewall which narrows in a stepwise manner. The side wall 527 of secondary swirl chamber 526 tapers, and thus the diameter tapers, in the direction of fluid flow. As shown in FIG. 31, side wall 527 of secondary swirl chamber 526 forms an angle α relative to a longitudinal axis of the nozzle insert of from about 20 to about 30 degrees, or from about 22 to about 28 degrees, or from about 24 to about 27 degrees.

Referring to FIG. 29, the secondary swirl chamber 526 may have a first diameter 554a and a second diameter 554b. The first diameter 554a may be greater than the second diameter 554b. In some aspects, the first diameter 554a may be the maximum diameter of the secondary swirl chamber and may be measured at the widest point of the swirl chamber adjacent to the end face 531. In some aspects, the second diameter 554b may be the minimum diameter of the secondary swirl chamber and may be measured at the narrowest point of the secondary swirl chamber adjacent to the exit orifice. The first diameter 554a may be from about 0.6 mm to about 2 mm, or from about 1.0 mm to about 1.6 mm. The second diameter 554b may be from about 0.5 mm to about 1 mm, or from about 0.7 mm to about 1 mm. In some aspects, a ratio of the first diameter of the secondary swirl chamber to the second diameter of the secondary swirl chamber may be greater than about 1 and less than about 1.6. In some aspects, a ratio of the first diameter of the secondary swirl chamber to the second diameter of the secondary swirl chamber may be about 1.5.

In some aspects, the secondary swirl chamber 526 may have a depth 556 of from about 0.1 mm to about 2 mm, or from about 0.4 mm to about 1 mm, or from about 0.5 mm to about 0.8 mm.

The exit orifice 504 may have a side wall 506 that extends in a continuous increasing taper from an entrance end of the exit orifice adjacent to the secondary swirl chamber to an opposing exit end such that the diameter of the exit orifice 504 increases in a direction of fluid flow. As shown in FIG. 31, side wall 506 of exit orifice 504 forms an angle R relative to a longitudinal axis of the nozzle insert of from about 4 to about 12 degrees, or from about 6 to about 10 degrees. Without being limited by theory, it is believed that the decreasing taper of the secondary swirl chamber can drive turbulent flow of the fluid and the increasing taper of the exit orifice can drive the shape (cone angle) of the spray pattern of the fluid coming out of the nozzle.

The exit orifice 504 may have a first diameter 546a and a second diameter 546b. The first diameter 546a may be smaller than the second diameter 546b. In some aspects, the first diameter 546a may be the minimum diameter of the exit orifice and may be measured at the narrowest point of the exit orifice adjacent to the secondary swirl chamber. In some aspects, the second diameter 546b may be the maximum diameter of the exit orifice and may be measured at the widest point of the exit orifice adjacent to the exit end of the exit orifice. The first diameter 546a may be from about 0.2 mm to about 0.5 mm, or from about 0.3 mm to about 0.4 mm. The second diameter 546b may be from about 0.5 mm to about 0.8 mm, or from about 0.6 mm to about 0.7 mm. In some aspects, a ratio of the second diameter of the exit orifice to the first diameter of the exit orifice may be greater than about 1 and less than about 2, or from about 1.2 to about 1.8. In some aspects, a ratio of the second diameter of the exit orifice to the first diameter of the exit orifice may be about 1.5.

In some aspects, the exit orifice 504 may have a depth 548 (also referred to as “land length”) of from about 0.8 mm to about 1.5 mm, or from about 0.9 mm to about 1.1 mm.

Although FIG. 29 depicts the secondary swirl chamber 526 defined by the nozzle insert 502, in other configurations the secondary swirl chamber 526 may be defined by the insert post 508.

The actuator assembly 303′ will now be discussed, without the nozzle insert 502. FIG. 33 is a cross-sectional view taken along line F-F in FIG. 34 of the actuator assembly 303′ with the nozzle insert 502 removed. FIG. 34 is a top view of the actuator assembly 303′ of FIG. 26 with the nozzle insert 502 removed. FIGS. 35 and 36 are various views of the nozzle body 506 of the actuator assembly 303′ of FIG. 33. FIG. 36 is a cross-sectional view taken along line G-G in FIG. 38 of the nozzle body 506 of the actuator assembly 303′. FIG. 38 is a top view of the nozzle body 506 of the actuator assembly 300′ of FIG. 33.

As previously discussed, the nozzle body 506 of the improved nozzle 500 design may configured for receiving and retaining the nozzle insert 502. The nozzle body 506 may be in fluid communication with the aerosol valve 220 and may include an insert post 508 having an end surface 510 (FIG. 36). As further shown in FIG. 36, one or more grooves 540 may be formed in the end surface 510 of the insert post 508.

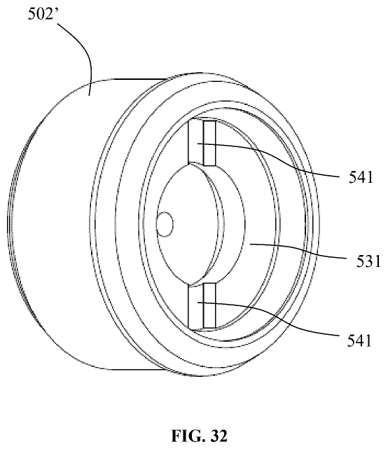

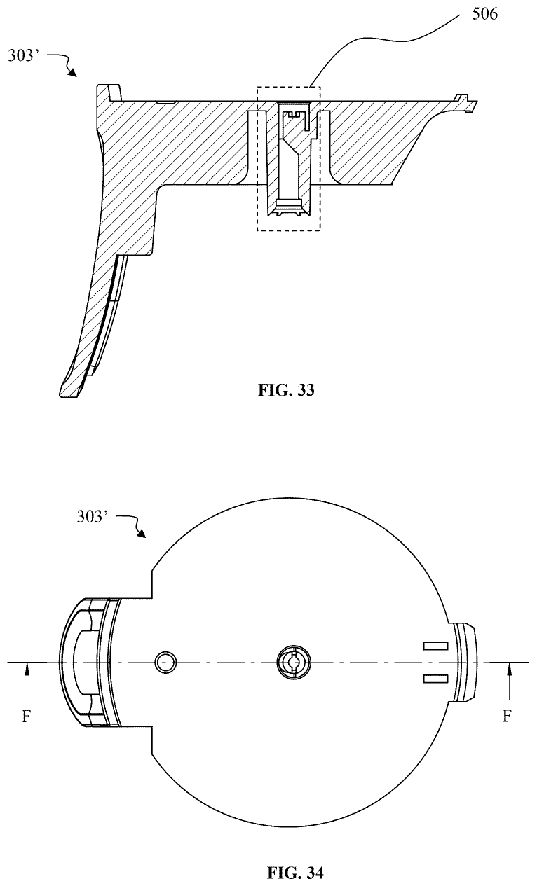

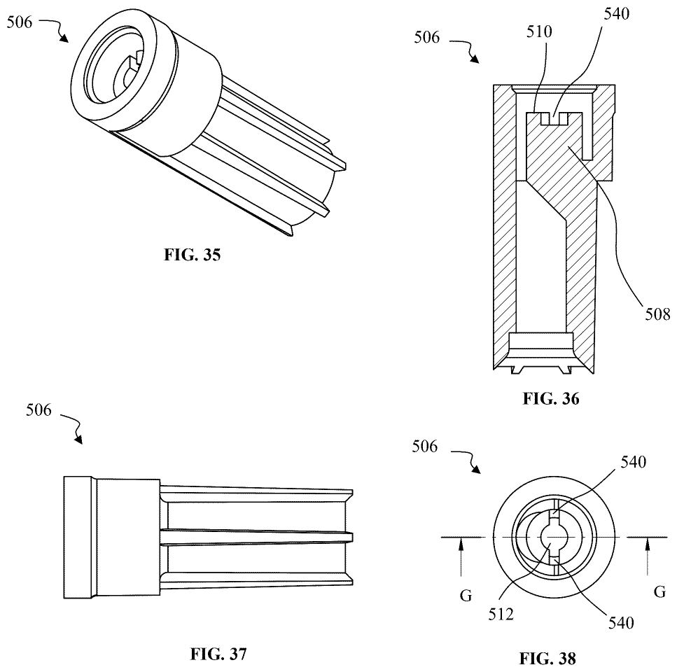

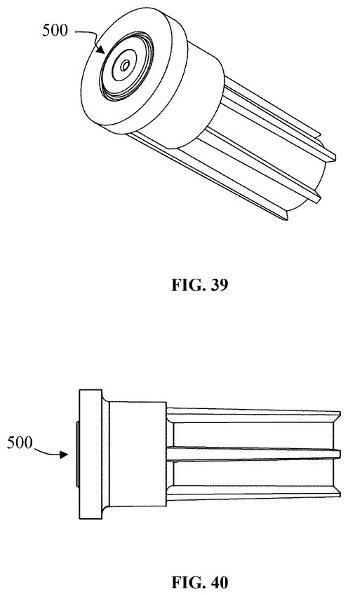

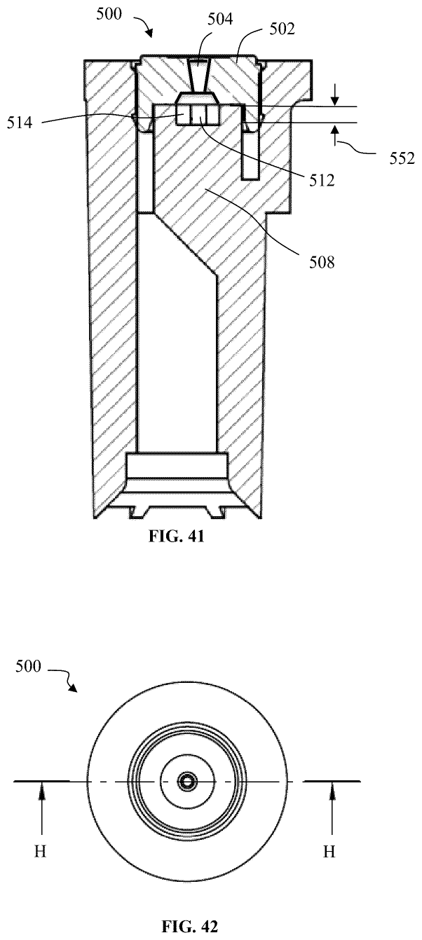

FIGS. 39 and 40 are various views of the improved nozzle 500 design showing the nozzle insert 502 disposed on the insert post 508 of the nozzle body 506. FIG. 41 is a cross-sectional view taken along line H-H in FIG. 42 of the improved nozzle 500 design. FIG. 42 is a top view of the improved nozzle 500 design.

As shown in FIG. 41, the nozzle 500 may define a primary swirl chamber 512 in fluid communication with one or more inlet ports 514. The volume of the primary swirl chamber 512 may be within a preferred range of values, such as between about 1.5 mm³ and about 9 mm³, or between about 1.5 mm³ and about 3 mm³.

In some aspects, the secondary swirl chamber volume may be less than the primary swirl chamber volume. In some aspects, a ratio of the primary swirl chamber volume to the secondary swirl chamber volume may be greater than about 1.4, or from about 1.5 to about 3. In some aspects, a ratio of the primary swirl chamber volume to the secondary swirl chamber volume may be about 2.8.

The primary swirl chamber 512 may have a diameter 550 (as shown in FIG. 52) of from about 0.6 mm to about 2 mm, or from about 1 mm to about 1.8 mm, or from about 1.5 mm to about 1.7 mm. In some aspects, the primary swirl chamber may comprise side walls which are substantially parallel such that the diameter of the swirl chamber is substantially similar along the primary swirl chamber depth. In some aspects, a ratio of the primary swirl chamber maximum diameter to a secondary swirl chamber maximum diameter may be greater than 1. Without being limited by theory, it is believed that slowing the flow of fluid prior to the exit orifice can help to create a more turbulent flow and can enable particle size breakup.

In some configurations, each inlet port 514 may be formed by the grooves 540 formed in the end surface 510 of the insert post 508 (FIG. 36) and the end face 531 of the nozzle insert 502 (FIG. 28). In some configurations, the nozzle insert 502 may be positioned in the nozzle body 506 such that the inlet port(s) 514 of FIG. 41 may be defined between the grooves 540 in the end surface 510 of the insert post 508 and the end face 531 of the nozzle insert 502. In this configuration, no grooves may be formed in the end face 531 of the nozzle insert 502.

Although some configurations may form the inlet port(s) 514 between grooves 540 formed in the end surface 510 of the insert post 508 and the end face 531 of the nozzle insert 502, in other configurations the inlet port(s) 514 may be defined by a different structural configuration. For example, as shown in FIG. 32, grooves 541 may be formed in the end face 531 of the nozzle insert 502′ and such grooves 541 may form the inlet port(s) 514 along with the grooves 540 formed in the end surface 510 of the insert post 508 (e.g. where such grooves 541 formed in the end face 531 of the nozzle insert 502′ and grooves 540 formed in the end surface 510 of the insert post 508 are aligned to form the inlet port(s) 514). However, in yet another configuration, the grooves 540 may not be formed in the end surface 510 of the insert post 508 and thus the inlet port(s) 514 may be formed by grooves 541 in the end face 531 of the insert post 502′ and a flat end surface 510 without grooves, when the nozzle insert 502′ is received within the nozzle body 506.

As further shown in FIG. 41, the exit orifice 504 may be disposed generally concentric with the swirl chamber 512 and may be in fluid communication therewith. The one or more inlet ports 514 may be in fluid communication with the aerosol valve 220.

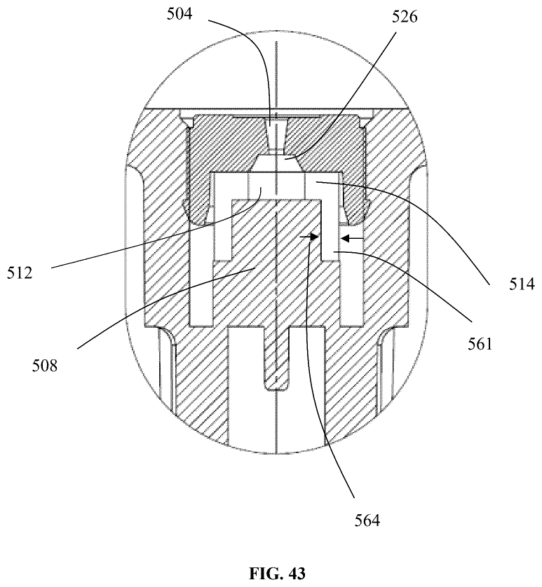

As shown in FIG. 43, a vertical channel 561 may be cut into the insert post 508. It will now be described how the fluid flows through the valve stem 223 and into the nozzle 500. After exiting the valve stem 223, the composition may longitudinally traverse the nozzle body 506 and enter the vertical channel 561. The composition may then turn (e.g., about 90 degrees) into the inlet port(s) 514 and may then be directed toward primary swirl chamber 512. The composition may exit the inlet ports 514 and enter the primary swirl chamber 512 non-tangentially for one or more desired effects (e.g. substantially avoid swirl). The composition may then be directed into the secondary swirl chamber 526 and out through the exit orifice 504 to the ambient environment. The nozzle insert 502 and the nozzle body 506 and/or insert post 508 may be made from a certain material, such as acetal. In some configurations, the insert post 508 may be made from polypropylene and the nozzle insert 502 may be made from acetal.

The nozzle 500 is configured to create opposing flow paths such that at least a portion of the front of each flow path crashes into one another before exiting the nozzle 500 through the exit orifice 504. Unlike conventional nozzle designs, where the flow paths from the inlet ports either do not intersect within the primary swirl chamber 512 or intersect at a substantially orthogonal angle, the flows paths of the improved nozzle design 500 herein intersect within the primary swirl chamber 512 and are at least partially aligned. Thus, the flow paths from each inlet port 514 of the improved nozzle design 500 may intersect within the primary swirl chamber 512 and each flow path may have at least one non-zero component that are aligned in a common direction. It was recognized that this arrangement of the inlet ports 514 in the improved nozzle 500 design may substantially reduce swirl within the primary swirl chamber 512, as compared to conventional nozzle designs, which may achieve one or more desired outcomes (e.g. increased spray droplet size, increased spray force from the nozzle orifice, etc.).

### Non-Tangential Inlet Port Designs

Exemplary configurations will now be discussed of various designs of the one or more inlet ports 514 and the primary swirl chamber 512 of the improved nozzle 500 design. Each of these configurations may show a different non-tangential arrangement of the one or more inlet ports 514 with respect to the primary swirl chamber 512. These designs may feature different structural arrangements of one or more grooves 540 formed in the end surface 510 of the insert post 508, which may respectively form one or more inlet ports 514 (e.g. with the end face 531 of the nozzle insert 502). However, in other designs where the inlet port(s) 514 are formed with grooves 541 formed in the end face 531 of the nozzle insert 502′ (FIG. 32), such grooves 541 formed in the nozzle insert end face 531 may have a similar arrangement and/or orientation, relative to the swirl chamber 512, as the grooves 540 in each of the configurations discussed herein.

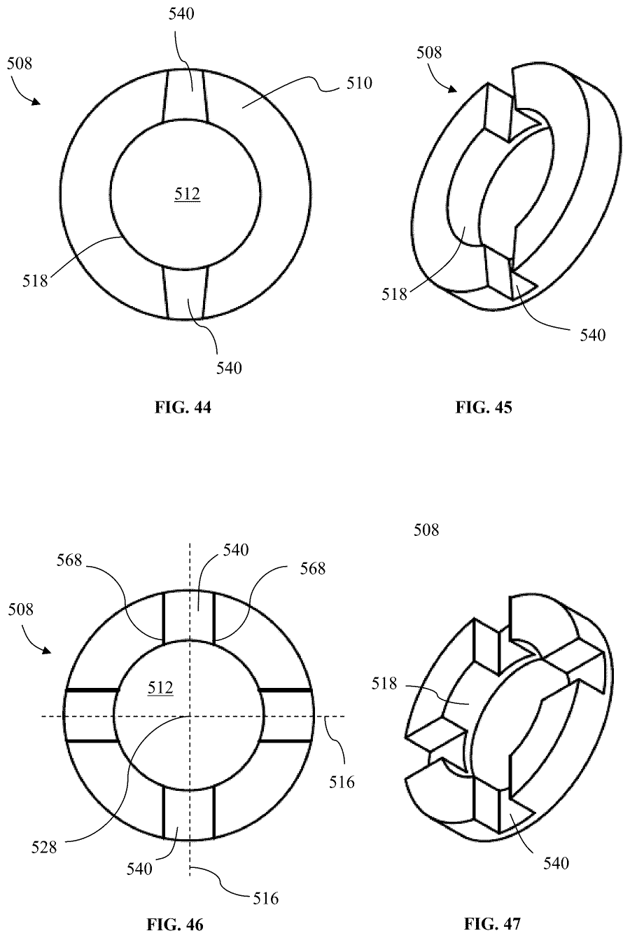

FIGS. 44 through 59 are various partial top and perspective views of different insert post 508 designs for the improved nozzle 500 design of FIG. 25. Each particular design will now be discussed, along with the distinct features of each design.

FIGS. 44 and 45 depict one configuration of a design of the insert post 508 featuring a pair of grooves 540 formed in the end surface 510. Thus, in some configurations, more than one groove 540 is formed in the end surface 510 and thus more than one inlet port 514 may be defined in the improved nozzle 500 design. However, in another configuration, only one groove 540 may be formed in the end surface 510 and thus in this example only one inlet port 514 may be defined in the improved nozzle 500 design. The grooves 540 of FIGS. 44 and 45 enter the primary swirl chamber 512 (defined by outer wall 518) non-tangentially. As further shown in FIGS. 44 and 45, the grooves 540 may have a varying width such that the width of the grooves 540 may increase to a maximum value at a juncture with the swirl chamber 512. However, in other configurations, the grooves 540 may have a fixed or relatively fixed width along their length to the primary swirl chamber 512.

FIGS. 46 and 47 depict another configuration of a design of the insert post 508 featuring a plurality (e.g. four) of grooves 540 formed in the end surface 510. The grooves 540 of FIGS. 46 and 47 may enter the swirl chamber 512 non-tangentially. The grooves 540 may be arranged such that centerlines 516 of each of the grooves 540 may be substantially equidistant (e.g. circumferentially) apart along the outer wall 518 of the swirl chamber 512. Although FIGS. 46 and 47 depict four grooves 540, in other configurations where less or more than four grooves 540 are provided, each of the grooves 540 may be arranged so that the groove centerlines are substantially equidistant along the outer wall 518 of the swirl chamber 512.

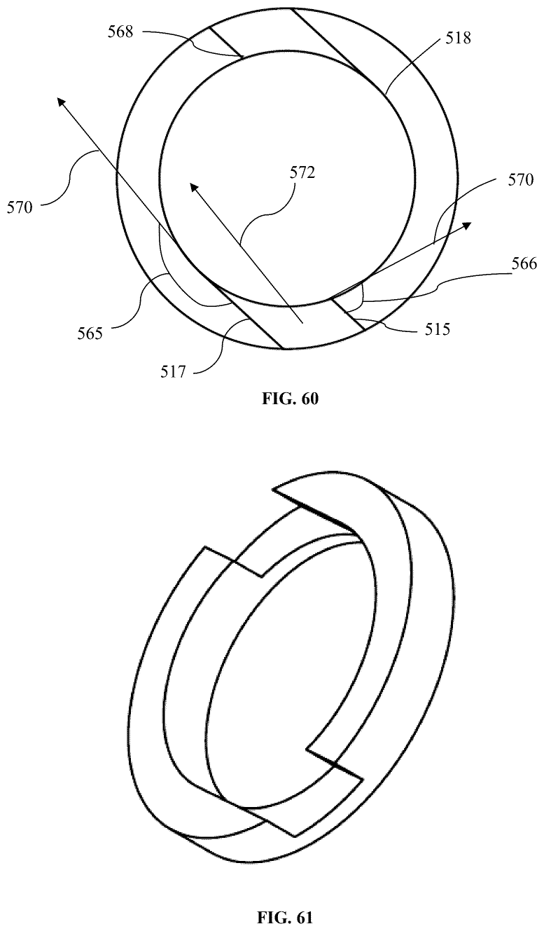

In some aspects, the non-tangential orientation of the grooves 540 with respect to the primary swirl chamber 512 may be indicated by the centerlines 516 of the grooves 540 which may intersect at a point within the primary swirl chamber 512. In the configuration depicted in FIGS. 46 and 47, the centerlines 516 may intersect at the center point 528 of the primary swirl chamber 512. This may be in stark contrast with tangentially oriented inlet ports (see FIGS. 60 and 61) whose centerlines do not intersect, let alone intersect at a center point within the primary swirl chamber 512.

In some aspects, the non-tangential orientation of the grooves 540 with respect to the primary swirl chamber 512 may be indicated by each groove 540 forming two corners 568 with the outer wall 518 of the primary swirl chamber 512. As shown in FIG. 46, each side of each groove 540 (e.g. leading side and trailing side) may form the corner 568 with the outer wall 518 of the primary swirl chamber 512. Each corner 568 features a surface of a side of the groove 540 that forms an angle (e.g. about 130 degrees) relative to the outer wall 518 of the swirl chamber 512. This may be in stark contrast with tangentially oriented inlet ports (see FIGS. 60 and 61) which each only form one corner 568 with the outer wall 518 of the primary swirl chamber 512.

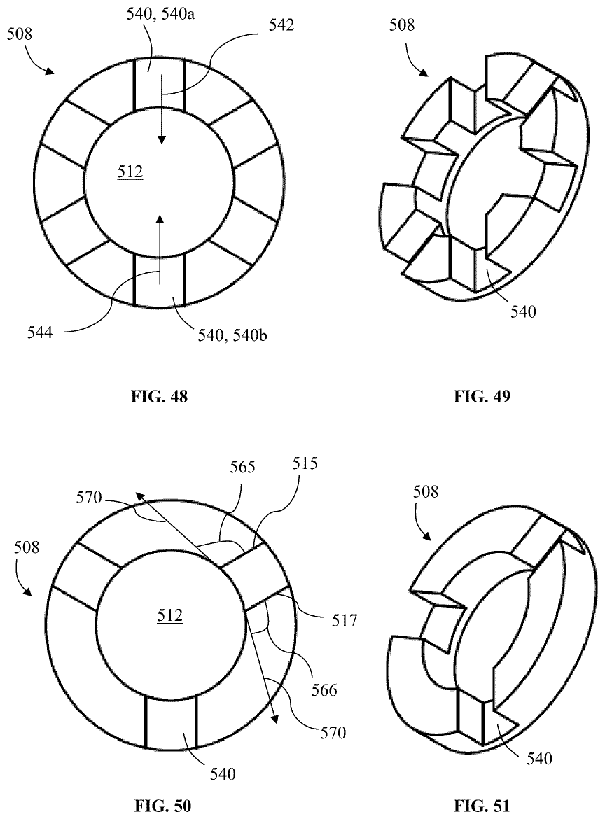

FIGS. 48 and 49 depict another configuration of a design of the insert post 508 featuring a plurality (e.g. six) of grooves 540 formed in the end surface 510. The grooves 540 of FIGS. 48 and 49 may enter the primary swirl chamber 512 non-tangentially. The grooves 540 may be arranged such that they may include a first groove 540a and a second groove 540b that are radially opposite to each other. In this configuration, as shown in FIG. 48, fluid is configured to flow from the first groove 540a in a first direction 542 to the interior of the primary swirl chamber 512 (e.g. toward the center point 528). Additionally, in this configuration, fluid is configured to flow from the second groove 540b in a second direction 544 to the interior of the primary swirl chamber 512 (e.g. toward the center point 528). The first direction 542 and the second direction 544 may intersect within (e.g. at the center point 528) within the primary swirl chamber 512. In some configurations, the first direction 542 and the second direction 544 may at least be partially aligned, such that each of the first direction 542 and the second direction 544 have a non-zero component aligned in a same direction (e.g. the vertical direction when viewing FIG. 48). In some configurations, the first direction 542 and the second direction 544 may be at least partially aligned such that they intersect within the primary swirl chamber 512 at a non-orthogonal angle. In this configuration, by intersecting within the primary swirl chamber 512 at a non-orthogonal angle, the first and second directions 542 and 544 are necessarily partially aligned such that they each have non-zero components aligned in a common direction. It was recognized that this design of the improved nozzle 500 disclosed herein ensures that at least a portion of a front of each flow path from each groove 540 crashes into each other in the primary swirl chamber 512 before exiting the nozzle through the exit orifice 504. Unlike designs where the first and second direction 542, 544 intersect within the primary swirl chamber 512 at an orthogonal angle, by ensuring that the first and second directions 542, 544 are at least partially aligned and thus intersect at a non-orthogonal, this design enhances the impact of the flow paths from the grooves 540 that crash together within the primary swirl chamber 512 and thus substantially reduce the degree of swirl within the primary swirl chamber 512.

FIGS. 50 and 51 depict another configuration of a design of the insert post 508 featuring a plurality (e.g. three) of grooves 540 formed in the end surface 510. The grooves 540 of FIGS. 50 and 51 may enter the primary swirl chamber 512 non-tangentially. The grooves 540 may be arranged such that a leading side 515 of each groove 540 forms a first angle 565 with a direction 570 that is tangent to the outer wall 518 of the primary swirl chamber 512 at the juncture between the leading side 515 and primary swirl chamber 512. Similarly, in this configuration, grooves 540 may be arranged such that a trailing side 517 of each groove 540 forms a second angle 566 with a direction 570 that is tangent to the outer wall 518 of the primary swirl chamber 512 at the juncture between the trailing side 517 and primary swirl chamber 512. It is to be appreciated that the discussion herein of angles 565 and 566 may also apply to the inlet ports which are formed when the nozzle insert is disposed on the insert post.

In some aspects, the nozzle described herein may have a ratio of the first angle 565 to the second angle 566 of from about 1 to less than about 2, or from about 0.5 to about 1.9, or from about 0.8 to about 1.5, or from about 0.9 and about 1.3. This is in stark contrast with conventional nozzle designs, such as depicted in FIG. 60, where the first angle 565 is provided between the trailing side 517 of the groove 540 and a direction 570 that is tangent to the outer wall 518 of the swirl chamber 512, the second angle 566 is provided between the leading side 515 of the groove 540 and the tangential direction 570 and the ratio between the first angle 565 and the second angle 566 is about 2 or between about 2 and about 3. For purposes of this description, the ratio between the two angles is calculated by using the larger value angle (between the first and second angles 565, 566) and dividing this value by the smaller value angle (between the first and second angles 565, 566). It was recognized that swirl within the primary swirl chamber 512 may commence when the ratio exceeds about 2. Thus, the improved nozzle design herein, where the ratio may be in a range from about 1 to less than about 2 may reduce and/or minimize the extent of swirl within the primary swirl chamber 512 and thus achieve one or more desired characteristics of the spray of composition from the exit orifice 504 (e.g. increased composition particle size, increased spray force, etc.).

FIGS. 52 through 59 depict other configurations of a design of the insert post 508 featuring one or more grooves 540 formed in the end surface 510.

As previously discussed, each of the insert post 508 designs in FIGS. 44 through 59 may feature a non-tangential orientation of the grooves 540 with the primary swirl chamber 512. It was recognized that this arrangement may advantageously cause the fluid flowing through the grooves 540 to intersect or collide within the primary swirl chamber 512, to reduce the level of swirl within the primary swirl chamber 512. It was further recognized that this reduction or limitation of the degree of swirl within the primary swirl chamber 512 may advantageously lead to one or more desired spray characteristics of composition sprayed from the nozzle (e.g. spray rate, spray diameter, particle size, etc.).

Table 1 below provides examples of different spray nozzle arrangements including an exemplary inventive design (Examples B) and various comparative examples (Examples A and C-H). One or more dimensional parameter of each spray nozzle arrangement is provided in Table 1 below. The nozzle arrangements of Examples A-H include a nozzle insert having 2 non-tangentially arranged inlet ports as shown in FIG. 38, an inlet port depth of 0.80 mm, an inlet port width of 0.64 mm, a vertical channel width of 0.64 mm, and a vertical channel depth of 0.52 mm.

The exit orifice first and second diameters 546a, 546b and the exit orifice land length 548 may be depicted in FIG. 29. The primary swirl chamber diameter 550 and swirl chamber depth 552 may be depicted in FIGS. 52 and 53. The secondary swirl chamber first and second diameters 554a, 554b and secondary swirl chamber depth 556 may be depicted in FIG. 29. The inlet port depth and inlet port width may correspond to the respective depth 560 and width 558 of the grooves 540 (FIGS. 52-53), such as where the inlet ports are defined by the grooves 540 and the end face 531 of the nozzle insert 502. The number of inlet ports may be based on the number of grooves 540.

TABLE 1

| Example | A | B | C | D | E | F | G | H |
|---|---|---|---|---|---|---|---|---|
| Exit Orifice First | 0.4 | 0.4 | 0.4 | 0.5 | 0.3 | 0.3 | 0.6 | 0.8 |
| Diameter (mm) | | | | | | | | |
| Exit Orifice Second | 0.8 | 0.6 | 0.4 | 0.5 | 0.3 | 0.3 | 0.6 | 0.8 |
| Diameter (mm) | | | | | | | | |
| Exit Orifice Side | 0 | 8 | 0 | 0 | 0 | 0 | 0 | 0 |
| Wall Angle β | | | | | | | | |
| (degrees) | | | | | | | | |
| Exit Orifice Land | 0.7 | 0.3 | 1.0 | 0.8 | 0.3 | 0.5 | 1.0 | 0.9 |
| Length (mm) | | | | | | | | |
| Primary Swirl | 1.7 | 1.7 | 1.7 | 1.7 | 1.7 | 1.7 | 1.7 | 1.7 |
| Chamber First | | | | | | | | |
| Diameter (mm) | | | | | | | | |
| Primary Swirl | 1.7 | 1.7 | 1.7 | 1.7 | 1.7 | 1.7 | 1.7 | 1.7 |
| Chamber Second | | | | | | | | |
| Diameter (mm) | | | | | | | | |
| Primary Swirl | 1.7 | 1.7 | 1.7 | 1.7 | 1.7 | 1.7 | 1.7 | 1.7 |
| Chamber Volume | | | | | | | | |
| (mm³) | | | | | | | | |
| Secondary Swirl | 2.5 | 1.5 | — | 1.8 | — | — | — | — |
| Chamber First | | | | | | | | |
| Diameter (mm) | | | | | | | | |
| Secondary Swirl | 2.5 | 1.0 | — | 1.1 | — | — | — | — |
| Chamber Second | | | | | | | | |
| Diameter (mm) | | | | | | | | |
| Secondary Swirl | 0 | 27 | — | 24 | — | — | — | — |
| Chamber Side Wall | | | | | | | | |
| Angle α (degrees) | | | | | | | | |
| Secondary Swirl | 4.3 | 0.6 | — | 1.3 | — | — | — | — |
| Chamber Volume | | | | | | | | |
| (mm³) | | | | | | | | |

The nozzle arrangements of Table 1 (Examples A-H) were then used to evaluate the spray parameters by discharging a water-based pest control composition from an aerosol dispensing device in a spray test. One or more spray parameters of each spray nozzle arrangement of Table 1 is provided in Table 2 below.

The spray test utilized to gather the data in Table 2 was conducted as follows: aerosol containers (591 mL volume) were filled with about 490 mL of composition (described herein after in Table 3) and pressurized to about 900 kPa using compressed nitrogen as the propellant and the container was equilibrated to 22° C. During the test, if the pressure in the container dropped below 830 kPa, the container was repressurized to about 830 kPa to about 900 kPa using nitrogen as the propellent before subsequent testing. Spray Rate was measured according to the Spray Rate Method, Spray Diameter was measured according to the Spray Diameter Method, and the spray droplet sizes (Dv10, Dv50, Dv90, D[3][2]) were measured according to the Spray Droplet Size Test Method.

TABLE 2

| Product | I | II | III | IV | V | VI | VII | VIII | IX |
|---|---|---|---|---|---|---|---|---|---|
| Nozzle | A | A | B | C | D | E | F | G | H |
| Composition | F-I | F-II | F-II | F-II | F-II | F-II | F-II | F-II | F-II |
| Spray Rate (g/f) | 3.6 | 3.8 | 4.0 | 4.6 | 5.2 | 2.4 | — | — | 7.2 |
| Spray Diameter | 10.7 | 8.9 | 15.5 | 13.5 | 14.2 | 9.6 | 8.9 | 6.4 | — |
| (cm) | | | | | | | | | |
| Dv10 (micron) | 93 | 130 | 64 | 110 | 110 | — | — | — | — |
| Dv50 (micron) | 288 | 350 | 120 | 270 | 290 | — | — | — | — |
| Dv90 (micron) | 646 | 680 | 280 | 610 | 610 | — | — | — | — |
| D[3][2] | 184 | 240 | 94 | 200 | 206 | — | — | — | — |
| (micron) | | | | | | | | | |

TABLE 3

| | F-I | F-II |
|---|---|---|
| Ingredient | (wt %) | (wt %) |
| Sodium Lauryl Sulfate | 6.50 | 6.00 |
| Cornmint Oil¹ | 1.00 | 1.00 |
| Geraniol² | 4.85 | 3.88 |
| Potassium Sorbate | — | 1.00 |
| Sodium Benzoate | — | 3.00 |
| Urea | 5.0 | — |
| Triethyl Citrate | 6.5 | 5.50 |
| Isopropyl Alcohol | 2.7 | 2.00 |
| Citric Acid | 0.001 to | 0.14 to |
| | 0.1 | 0.59 |
| Trisodium Citrate | 0.25 | 0.25 |
| DI Water | QS | QS |
| pH | 6.0-6.5 | 5.5-6.5 |
| Viscosity at 22° C. | 7.0 | 287 |
| and 1 sec⁻¹ (cP) | | |
| Viscosity at 22° C. | 6.8 | 16 |
| and 500 sec⁻¹ (cP) | | |

¹Available from Ventos (Kenilworth, NJ).
²Available from BASF (Beaumont, TX).

It was found that when a non-Newtonian composition (F-II) was dispensed using the nozzle arrangement of Example A, the droplet size of the sprayed product was too big (in particular, a Dv50 of 350 microns) and the spray diameter was too narrow (8.9 cm), resulting in a spray that may not achieve the desired coverage of the target surface and thus may negatively impact efficacy. It was surprisingly found that dispensing the non-Newtonian composition (F-II) using the nozzle arrangement of Example B resulted in consumer preferable spray parameters, including droplet size, spray rate, and/or spray diameter, which can deliver a desirable coverage of the target surface. The nozzle arrangements of Example C, which contained no secondary swirl chamber, resulted in a droplet size that was too big (in particular, a Dv50 of 270 microns). The nozzle arrangements of Example D, which contained a secondary swirl chamber with a tapered side wall and an exit orifice with no tapered sidewall, resulted in a droplet size that was too big (in particular, a Dv50 of 270 microns). The nozzle arrangements of Examples E-H, which contained no secondary swirl chamber and varied the exit orifice diameter and land length, resulted in undesirable spray rates and/or spray diameters that may not achieve the desired coverage of the target surface.

With references to FIGS. 1-59, various configurations relate to an inverted aerosol dispensing device 100, comprising an aerosol container 200 extending between a top portion 201 and a bottom portion 202 for containing composition 210 and a propellant 212 therein. The device 100 may also comprise an aerosol valve 220 located at the bottom portion 202 of the aerosol container 200. The aerosol valve 220 may have a valve stem 223 for displacing the aerosol valve 220 from a biased closed position 221 to an open position 222 upon a movement of the valve stem 223 to discharge the pest control composition 210 from the valve stem 223. The device 100 may also comprise an undercap 300 having a sidewall 310 extending between a top portion 301 and a bottom portion 302. The undercap 300 may be mounted to the aerosol container 200 with the top portion 301 of the undercap 300 being adjacent to the bottom portion 202 of the aerosol container 200. The bottom portion 302 of the undercap 300 may terminate in a base surface 320 for supporting the aerosol dispensing device 100 on a supporting surface 400 to store the aerosol dispensing device 100 in an inverted position 110. The device 100 may also comprise an actuator assembly comprising an actuator lever 330 located adjacent and outboard of the sidewall 310 of said undercap 300, being movably mounted relative to the undercap 300 and configured to move the valve stem 223 when the actuator lever 330 is moved. In some configurations, when the valve stem 223 displaces the aerosol valve 220 to the closed position 221 the exit orifice 224 of the valve stem 220 is substantially parallel to the base surface 320 of the bottom portion 302 of the undercap 300 and when the valve stem 223 displaces the aerosol valve 220 to the open position 222 the exit orifice 224 of the valve stem 223 may be from about 3 degrees to about 8 degrees out of plane with respect to the base surface 320 of the bottom portion 302 of the undercap 300. The valve stem 223 may preferably be biased towards the actuator lever 330.

The actuator assembly 303′ disclosed herein may also feature the improved nozzle 500 design described herein, which may achieve one or more desired spray characteristics of the composition sprayed from the device 100.

Various configurations relate to an inverted aerosol dispensing device 100, comprising an aerosol container 200 extending between a top portion 201 and a bottom portion 202 for containing a composition 210 and a propellant 212 therein. The device 100 may also comprise an aerosol valve 220 located at the bottom portion 202 of the aerosol container 200, a valve 240 located adjacent the aerosol valve 220, and a dip tube 230 with a first end 231 extending to and in fluid communication with the top portion of the aerosol container and a second end 232 extending to the bottom portion 202 of the aerosol container 200. The valve 240 may have a first inlet 241 in fluid communication with the second end 232 of the dip tube 230, a second inlet 242 in fluid communication with aerosol container 200, and an outlet 243 in fluid communication with the aerosol valve 220. The aerosol valve 220 may have a valve stem 223 for displacing the aerosol valve 220 from a biased closed position 221 to an open position 222 upon a movement of the valve stem 223 to discharge the composition 210 from the valve stem 223. The valve 240 may have a first position 244 when the aerosol container 200 is spatially oriented such that the top portion 201 of the aerosol container 200 is above the bottom portion 202 of the aerosol container 200 and a second position 245 when the aerosol container 200 is spatially oriented such that the top portion 201 of the aerosol container 200 is below the bottom portion 202 of the aerosol container 200. In some configurations, when the valve 240 is in the first position 244 the valve 240 closes the first inlet 241 preventing liquid communication between the first inlet 241 and the dip tube 230 and when the valve 240 is in the second position 245 the valve 240 closes the second inlet 242 preventing liquid communication between the second inlet 242 and the aerosol container 200. The device 100 may also comprise an undercap 300 having a sidewall 310 extending between a top portion 301 and a bottom portion 302. The undercap 300 may be mounted to the aerosol container 100 with the top portion 301 of the undercap 300 being adjacent to the bottom portion 202 of the aerosol container 200. The bottom portion 302 of the undercap 300 may terminate in a base surface 320 for supporting the aerosol dispensing device 100 on a supporting surface 400 to store the aerosol dispensing device 100 in an inverted position 110. The device 100 may also comprise an actuator assembly comprising an actuator lever 330 located adjacent the sidewall 310 of said undercap 300, being movably mounted relative to the undercap 300 and configured to move the valve stem 223 when the actuator 300 is moved. In some configurations, a rotatable portion 340 of the undercap 300 may be rotatable into a first rotational position 341 relative to the aerosol container 200 for enabling the actuator lever 330 to move the valve stem 223 upon movement of the actuator 330 for discharging the aerosol product 210 from the valve stem 223 in a generally downwardly direction 111. The undercap 300 may be rotatable into a second rotational position 342 relative to the aerosol container 200 for inhibiting the actuator lever 330 from moving the valve stem 223.

The device 100 described herein allows a composition to be dispensed when the device 100 is in an upright orientation 109 or in an inverted orientation 110. Thus, although the improved nozzle 500 design herein was previously discussed with respect to the actuator assembly 303′ of the inverted aerosol dispensing device 100, in other configurations the improved nozzle 500 design may be employed with a dispensing device in the upright orientation 109, such as the upright aerosol device disclosed in U.S. Patent Publication No. 2024/0292824, which is incorporated by reference herein.

As previously discussed, the improved nozzle 500 design of the device 100 in either the upright orientation 109 or inverted orientation 110 may achieve one or more desired spray characteristics of the sprayed composition product from the device 100. These one or more desired spray characteristics (e.g. spray rate, spray diameter, particle size, etc.) may advantageously achieve one or more desired performance characteristics (e.g. spraying an object, such as a plant positioned a certain distance from the device, from a spray position, such as a user in a standing position operating the device 100).

The improved nozzle design disclosed herein may be capable of spraying a certain composition (e.g. a non-Newtonian water-based pest control composition) and deliver a consumer preferable spray pattern and distance. Specifically, the nozzle 500 may include one or more inlet ports 514 which may enter the primary swirl chamber 512 non-tangentially. Preferably, the nozzle 500 may include at least two opposing inlet ports 514 (e.g. two opposing grooves 540). Traditional aerosol nozzles (e.g. FIGS. 60-61) may include a primary swirl chamber and tangentially positioned inlet ports which may create a swirling motion to the liquid in the chamber. As a result, a core of air may extend from the rear of the swirl chamber to the outlet orifice, resulting in the liquid being dispensed from the exit orifice as an annular sheet. It was recognized that it may be beneficial not to create substantial swirl in the chamber as it may create an undesirable wide spray pattern and small droplets, which may result in a non-targeted spray and an insufficient spray force to carry the composition the desired spray distance to the target (e.g. target plant). With the improved nozzle 500 geometry, a fluid flow path may be created which may be substantially free of swirl. Preferably, the nozzle 500 may be configured to create opposing flow paths wherein at least a portion of the front of each flow path may crash into one another before exiting the nozzle 500 through the exit orifice 504. The nozzle insert 502 may also contain the secondary swirl chamber 526 which may help to control the velocity of fluid flow before the fluid exits the nozzle 500. Although FIG. 29 depicts the secondary swirl chamber 526 formed in the nozzle insert 502, in other configurations the secondary swirl chamber may be formed in the insert post 508. Together, this nozzle 500 geometry may result in a consumer desirable cone spray pattern that can reach a target (e.g. target plant) from a desired spray distance (e.g. about 12-36 inches away). In some configurations, the desired spray cone pattern may have a spray cone angle between about 10 and about 26 degrees.

### Composition

The composition may be a liquid composition which may be housed within the container attached to the spray dispenser. The composition may be a consumer use product intended to be sprayed onto a target surface. Non-limiting examples of consumer use products include pest control products such as herbicides, insecticides, insect barrier products, and/or garden insecticides. In some aspects, the composition may be a pest control composition. In some aspects, the composition described herein may be a non-selective burn-down herbicide.

As used herein, “pest control” means the management of a pest species, including any animal, such as insects and other arthropods, plant, or fungus that adversely impacts human activities or the environment, where management includes controlling, killing, eliminating, repelling, or attracting the pest species. The terms “pest control” and “pesticide” are used interchangeably and it is understood that a composition or an ingredient that has “cidal” activity, e.g., pesticide, insecticide, herbicide, fungicide, may or may not kill and/or eliminate the target pest, e.g., arthropod, insect, weed, or fungus. As used herein, “cide” and “cidal” includes compositions, compounds, components, ingredients, materials, etc., which are effective to kill, remove, destroy, defoliate, exterminate, eradicate, eliminate, etc., a target pest, as well as to retard, regulate, inhibit, prevent, etc., the survival, growth, and/or proliferation of such pest. Pest control compositions may include compositions for managing a pest species inside and outside of a building, such as a dwelling or a business, including, but not limited to, areas such as garages, patios, balconies, screened porches, lawns, and/or gardens. Pest control compositions may include compositions for use in and/or on yards, lawns, bushes, trees, and/or outdoor plants, as well as for use on or around indoor plants. Pest control compositions may include selective and non-selective products and compositions, such as selective and non-selective herbicides, fungicides, and insecticides. Pest control compositions may also include compositions for topical application to humans to control or repel pest species, such as insects and other arthropods.

The composition may be an aqueous composition. The composition may comprise from about 40% to about 99%, or from about 45% to about 98%, by weight of the composition of water. The composition may comprise from about 40% to about 97% water, or from about 60% to about 95%, or from about 50% to about to about 92%, or from about 70% to about to about 90%, or from about 55% to about 83%, or from about 78% to about 80%, or from about 58% to about 78%, or from about 60% to about 75%, or from about 62% to about 72%, all by weight of the composition.

The composition may be provided in the form of a ready-to-use composition, which can be directly applied to a target surface (e.g., as a spray) and need not be diluted by a consumer before use. Ready-to-use compositions may be preferred by some consumers, because ready-to-use compositions do not require dilution by the consumer, which may be messy, inconvenient, and/or require multiple containers.

The composition may be substantially free of geologically derived (e.g., petroleum-based) oils, such as mineral oil. Compositions containing geologically derived oils, such as mineral oil, may leave a residue on a treated surface and may be generally messy to use.

The composition may have a pH ranging from about 3.0 to about 11.0, or from about 4.0 to about 11.0, or from about 4.0 to about 9.0, or from about 5.0 to about 9.0, or from about 5.0 to about 8.0, or from about 6.0 to about 8.0, or from about 6.0 to about 7.0. In some aspects, the composition may have a pH of from about 4.8 to about 8.0, or from about 5.0 to about 7.5, or from about 5.5 to about 6.5. In some aspects, the composition may have a pH from about 5.0 to about 6.5.

The composition described herein may comprise a microstructure with a hydrodynamic equivalent diameter of from about 10 nm to about 50 nm, or about 15 nm to about 45 nm, or about 22 nm to about 40 nm as measured according to Hydrodynamic Equivalent Diameter Test Method.

The composition may be a “low VOC” composition and comprise about 3% volatile organic compounds (VOCs) by weight or less. Alternatively, the composition may comprise greater than 3% volatile organic compounds (VOCs) by weight. The composition may comprise greater than 3% to about 35% by weight of volatile organic compound (VOC). VOCs can be measured according to the California Air Resources Board (CARB) Method 310 for VOC determination (May 25, 2018).

The composition may exhibit a temperature dependent shear thinning behavior. The composition may exhibit a first viscosity of from about 15 cP to about 1,000 cP, or from about 20 cP to about 900 cP, or from about 25 cP to about 900 cP, or from about 40 cP to about 750 cP, at a shear rate of 1 sec⁻¹ measured at 22° C. The composition may exhibit a second viscosity of from about 1 cP to about 50 cP, or from about 5 cP to about 40 cP, or from about 10 cP to about 35 cP, at a shear rate of 500 sec⁻¹ measured at 22° C. The composition may exhibit a first viscosity of from about 15 cP to about 1,000 cP at a shear rate of 1 sec⁻¹ measured at 22° C. and a second viscosity of from about 1 cP to about 50 cP at a shear rate of 500 sec⁻¹ measured at 22° C.

It was surprisingly found that the viscosity of the composition thickens substantially at lower temperatures. The composition may exhibit a first viscosity of from about 15 cP to about 1,500 cP, or from about 50 cP to about 1,000 cP, or from about 100 cP to about 800 cP, at a shear rate of 1 sec⁻¹ measured at 15° C. The composition may exhibit a second viscosity of from about 1 cP to about 50 cP, or from about 10 cP to about 40 cP, or from about 15 cP to about 35 cP, at a shear rate of 500 sec⁻¹ measured at 15° C. The composition may exhibit a first viscosity of from about 15 cP to about 1,500 cP at a shear rate of 1 sec⁻¹ measured at 15° C. and a second viscosity of from about 1 cP to about 50 cP at a shear rate of 500 sec⁻¹ measured at 15° C.

The composition may be non-Newtonian (i.e., the viscosity is dependent on shear rate). The composition may exhibit a ratio of the first viscosity to the second viscosity measured at 22° C. of at least 1.5, or from about 2 to about 25, or from about 3 to about 20. The composition may exhibit a ratio of the first viscosity to the second viscosity measured at 15° C. of at least 1.5, or from about 2 to about 30, or from about 10 to about 25. The composition may exhibit a ratio of the first viscosity measured at 15° C. to the first viscosity measured at 22° C. of at least 1.5, or from about 1.75 to 25, or from about 1.8 to about 20. The composition may exhibit a ratio of the second viscosity measured at 15° C. to the second viscosity measured at 22° C. of at least 1.4, or from about 1.5 to 8, or from about 1.5 to about 5.

In some aspects, the composition may comprise a lyotropic liquid crystalline microstructure. As used herein, “lyotropic liquid crystalline microstructure” refers to a self-assembled structure comprising a surfactant that exhibits some degree of repeat microstructural order similar to a solid crystal. In some examples, the repeat spacing of the lyotropic liquid crystalline microstructure may be of a length scale, in at least one dimension, short enough that it is capable of impeding, retarding, slowing, or otherwise altering the free molecular reorientation of water. Examples of lyotropic crystalline microstructures can include structures formed in a sponge phase, lamellar phase, cubic phase, hexagonal phase, nematic phase, and combinations thereof. It is to be appreciated that micelle (spherical, worm-like, and/or branched) and/or uni-lamellar vesicles are surfactant aggregate structures that are not considered to be lyotropic liquid crystalline microstructures.

### Active Ingredients

The composition may comprise one or more active ingredients (also referred to herein as actives). In some aspects, the composition may comprise from about 0.005% to about 30%, or from about 0.005% to about 25%, or from about 0.05% to about 20%, or from about 0.15% to about 18%, or from about 0.15% to about 15%, or from about 0.5% to about 12%, or from about 0.5% to about 10%, by weight of the composition, of one or more active ingredients. In some aspects, the composition may comprise from about 0.5% to about 12%, or from about 1% to about 10%, or from about 3% to about 8%, or from about 4% to about 7%, by weight of the composition, of the one or more active ingredients.

Suitable active ingredients may include plant oils/essential plant oils (including synthetic analogues) and/or constituents thereof (including synthetic analogues). In some aspects, the active ingredient may be a natural oil. Examples of active ingredients include aldehyde C16 (pure), almond oil, alpha-terpineol, verbenone, alpha-cedrene, cinnamic aldehyde, amyl cinnamic aldehyde, cinnamyl acetate, amyl salicylate, anisic aldehyde, cedrol, benzyl acetate, cinnamaldehyde, cinnamic alcohol, carvacrol, carveol, citral, citronellal, citronellol, dimethyl salicylate, eucalyptol (also known as 1,8-cineole), thujopsene, 3-thujopsanone, alpha-thujone, beta-thujone, fenchone, eugenyl acetate (e.g., isoeugenyl acetate), d-limonene, linalool, alpha-pinene, tetrahydrolinalool, ethyl cinnamate, eugenol, iso-eugenol, methyl iso-eugenol, galaxolide, geraniol, guaiacol, ionone, menthol (e.g., L-menthol), menthone, carvone (e.g., L-carvone), camphor, p-cymene, bornyl acetate, isobornyl acetate, gamma-terpinene, methyl anthranilate, methyl ionone, methyl salicylate, nerol, alpha-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, thymol, trans-anethole, vanillin, ethyl vanillin, castor oil, cedar oil, cinnamon, cinnamon oil, citronella, citronella oil, clove, corn oil, cornmint oil, cottonseed oil, garlic, garlic oil, linseed oil, mint, mint oil, thyme, peppermint, peppermint oil, spearmint, spearmint oil, rosemary, sesame, sesame oil, soybean oil, white pepper, licorice oil, wintergreen oil, star anise oil, lilac flower oil, black seed oil, grapefruit seed oil, grapefruit, lemon oil, orange oil, tea tree oil, tagete minuta oil, lavender oil, lippia javancia oil, oil of bergamot, galbanum oil, lovage oil, and combinations thereof.

Examples of essential oils include thyme (thymol, carvacrol), oregano (carvacrol, terpenes), lemon (limonene, terpinene, phellandrene, pinene, citral), orange flower (linalool, β-pinene, limonene), orange (limonene, citral), anise (anethole, safrol), clove (eugenol, eugenyl acetate, caryophyllene), rose (geraniol, citronellol), rosemary (borneol, bornyl esters, camphor), geranium (geraniol, citronellol, linalool), lavender (linalyl acetate, linalool), citronella (geraniol, citronellol, citronellal, camphene), eucalyptus (eucalyptol), peppermint (menthol, menthyl esters), spearmint (carvone, limonene, pinene), wintergreen (methyl salicylate), camphor (safrole, acetaldehyde, camphor), bay (eugenol, myrcene, chavicol), cinnamon (cinnamaldehyde, cinnamyl acetate, eugenol), tea tree (terpinen-4-ol, cineole), cedar leaf (α-thujone, β-thujone, fenchone), geranium (Citronellol, Geraniol, guaiadiene), cornmint (Menthol, Menthone), garlic (dimethyl trisulfide, diallyl disulfide, diallyl sulfide, diallyl tetrasulfide, 3-vinyl-[4H]-1,2-dithiin), and combinations thereof.

In some aspects, the composition may comprise about 0.005% to about 15%, or from about 0.05% to about 15%, or from about 0.15% to about 12%, or from about 0.5% to about 10% of one or more active ingredients selected from the group consisting of eugenol, 2-phenylethyl propionate, menthol, menthone, amyl butyrate, geraniol, limonene (e.g., d-limonene), p-cymene, linalool, linalyl acetate, camphor, methyl salicylate, pinene (e.g., alpha-pinene, beta-pinene), eucalyptol, piperonal, piperonyl alcohol, tetrahydrolinalool, thymol, carvone (e.g., L-carvone), vanillin, ethyl vanillin, iso-eugenol, bornyl acetate, isobornyl acetate, terpinene (e.g., gamma-terpinene), cinnamyl acetate, cinnamic alcohol, cinnamaldehyde, ethyl cinnamate, pyrethrins, abamectin, azadirachtin, amitraz, rotenone, boric acid, spinosad, biopesticides, synthetic pesticides, and mixtures thereof. In some aspects, the composition may comprise from about 0.05% to about 3%, or from about 0.1% to about 2%, or from about 0.4% to about 1% menthol by weight of the composition.

In some aspects, the active ingredient may be a pesticidal and/or herbicidal active. The pesticidal and/or herbicidal active may be a plant extract, constituent thereof, or synthetic analogue thereof selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof.

In some aspects, the active ingredient may be a synthetic pesticide. Examples of synthetic pesticides include pyrethroids, such as bifenthrin, esfenvalerate, fenpropathrin, permethrin, cypermethrin, cyfluthrin, deltamethrin, allethrin, lambda-cyhalothrin, or the like; syngergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. In some aspects, the composition may comprise less than about 10%, or less than about 5%, or less than about 2%, or less than about 1%, or less than about 0.5%, or less than about 0.1% by weight of the composition of a synthetic pesticide. Alternatively, the composition may be substantially free of a synthetic pesticide.

In some aspects, the active ingredient may comprise one or more biopesticides. Examples of biopesticides include pyrethrum, rotenone, neem oil, and mixtures thereof.

In some aspects, the composition may comprise an essential oil comprising menthol, such as cornmint oil and/or peppermint oil, and an additional active chosen from rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof, preferably chosen from geraniol, rosemary oil, thyme oil, lemongrass oil, citronella oil, and mixtures thereof. In some aspects, the composition may comprise an active ingredient wherein the active ingredient is a plant extract, constituent thereof, or synthetic analogue thereof selected from the group consisting of cornmint oil, peppermint oil, menthol, geraniol, and combinations thereof.

In some aspects, the composition may comprise from about 0.1% to about 7.5% cornmint oil and from about 1% to about 6% geraniol, all by weight of the composition. It is believed that cornmint oil (menthol) may improve the low temperature stability of compositions containing anionic surfactants, such as SLS.

### Surfactant

The composition may be formulated with one or more surfactants. The composition may comprise from about 1% to about 12%, or from about 4% to about 10%, or from about 6% to about 8%, by weight of the composition, of one or more surfactants, preferably one or more anionic surfactants.

Suitable surfactants include anionic surfactants, amphoteric surfactants, zwitterionic surfactants, nonionic surfactants, cationic surfactants, or mixtures thereof. Anionic surfactants are surfactant compounds that contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants. Anionic surfactants include the alkali metal, ammonium and alkanol ammonium salts of organic sulfuric reaction products having in their molecular structure an alkyl or alkaryl group containing from about 8 to about 22 carbon atoms and a sulfonic or sulfuric acid ester group. Examples of such anionic surfactants include water soluble salts and mixtures of salts of alkyl benzene sulfonates having from about 8 to about 22 carbon atoms in the alkyl group (e.g., linear alkyl benzene sulfonates, such as dodecylbenzene sulfonate and salts thereof), alkyl sulfates and alkali metal salts thereof (e.g., sodium dodecyl sulfate), alkyl ether sulfates having from about 8 to about 22 carbon atoms in the alkyl group and about 2 to about 9 moles of ethylene oxide. Aryl groups generally include one or two rings, alkyl groups generally include from about 8 to about 22 carbon atoms, and ether groups generally comprise from about 1 to about 9 moles of ethylene oxide (EO) and/or propylene oxide (PO), preferably EO.

A preferred anionic surfactant is sodium lauryl sulfate or “SLS” (also known as sodium dodecyl sulfate). The composition may comprise from about 4% to about 10%, or from about 6% to about 8%, by weight of the composition of sodium lauryl sulfate. In some aspects, the composition may comprise a surfactant consisting essentially of sodium lauryl sulfate.

Anionic surfactants may also include fatty acids and salts thereof. Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. The salts of fatty acids are also known as soaps and the counter ions of the salts may be sodium, potassium, calcium, magnesium, barium, iron, ammonium and amine salts of fatty acids. Fatty acid and the salts thereof may be linear, branched, saturated, unsaturated, cyclic, or mixtures thereof. Examples of fatty acids and salts thereof include octanoic acid, nonanoic acid, decanoic acid, lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof.

Additional suitable anionic surfactants include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, acyl methyl taurates, sulfoacetates, acyl lactates, and sulfosuccinamides.

Alternatively, the composition may be substantially free of fatty acids, as a fatty acid may be difficult to solubilize in an aqueous composition. In particular, the composition may be substantially free of lauric acid, oleic acid, stearic acid, or a combination thereof.

The composition may comprise an amphoteric surfactant, a zwitterionic surfactant, a nonionic surfactant, or a mixture thereof (in addition to or instead of an anionic surfactant). Amphoteric surfactants are surface active agents containing at least one anionic group and at least one cationic group and may act as either acids or bases, depending on pH. Some of these compounds are aliphatic derivatives of heterocyclic secondary and tertiary amines, in which the aliphatic substituent(s) may be straight or branched, at least one of the aliphatic substituents contains from about 6 to about 20, or from about 8 to about 18, carbon atoms, and at least one of the aliphatic substituents contains an anionic water-solubilizing group, e.g., carboxy, phosphonate, phosphate, sulfonate, sulfate.

Zwitterionic surfactants are surface active agents having a positive and negative charge in the same molecule, where the molecule is zwitterionic at all pHs. Zwitterionic surfactants include betaines and sultaines. The zwitterionic surfactants generally contain a quaternary ammonium, quaternary phosphonium, or a tertiary sulfonium moiety. Zwitterionic surfactants contain at least one straight chain or branched aliphatic substituent, which contains from about 6 to 20, or from about 8 to about 18, carbon atoms, and at least one aliphatic substituent containing an anionic water-solubilizing group, e.g., carboxy, sulfonate, sulfate, phosphate or phosphonate.

Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates, where the alkyl group has from 6 to about 20 carbon atoms. Other suitable amphoteric and zwitterionic surfactants include alkyliminomonoacetates, alkyliminidiacetates, alkyliminopropionates, alkyliminidipropionates, and alkylamphopropylsulfonates, where the alkyl group has from about 12 to about 18 carbon atoms, as well as alkyl betaines, alkylamidoalkylene betaines, alkyl sultaines, and alkylamidoalkylenehydroxy sulfonates.

The nonionic surfactant(s) may be any of the known nonionic surfactants, examples of which include condensates of ethylene oxide with a hydrophobic moiety. Nonionic surfactants include ethoxylated primary or secondary aliphatic alcohols having from about 8 to about 24 carbon atoms, in either straight or branch chain configuration, with from about 2 to about 40, or from about 2 and about 9 moles of ethylene oxide per mole of alcohol. Other suitable nonionic surfactants include the condensation products of alkyl phenols having from about 6 to about 12 carbon atoms with about 3 to about 30, or about 5 to about 14 moles of ethylene oxide. Nonionic surfactants also include ethoxylated castor oils and silicone surfactants, such as Silwet L-8610, Silwet L-8600, Silwet L-77, Silwet L-7657, Silwet L-7650, Silwet L-7607, Silwet L-7604, Silwet L-7600, and Silwet L-7280.

The composition may optionally comprise one or more cationic surfactants. Suitable cationic surfactants include quaternary ammonium surfactants and amino surfactants that are positively charged at the pH of the composition.

### Urea

The composition may comprise from about 0.1% to about 10%, or from about 0.5% to about 8%, or from about 1% to about 6%, by weight of the composition of urea. Without wishing to be bound by theory, it is believed that urea may improve the stability, availability, and/or solubility of the one or more active ingredients in the composition, thereby improving the efficacy of the composition without increasing the concentration of VOCs. Further, it is believed that urea may improve the low temperature stability of compositions containing anionic surfactants, such as SLS.

### Solvent

The compositions described herein may comprise from about 0.001% to about 15%, or from about 0.01% to about 12%, or from about 0.1% to about 10%, or from about 0.5% to about 8%, or from about 1% to about 5%, or from about 2% to about 4%, by weight of the composition of a solvent. Liquid compositions may comprise one or more solvents and water.

Suitable solvents include alcohols, such as monohydric or polyhydric alcohols. Preferred monohydric alcohols are low molecular weight primary or secondary alcohols exemplified by ethanol, propanol, and isopropanol, preferably isopropanol. Polyhydric alcohols, such as those containing from 2 to about 6 carbon atoms and from 2 to about 6 hydroxy groups (e.g., ethylene glycol, glycerin, and 1,2-propanediol (also referred to as propylene glycol)), may also be used.

Suitable solvents also include esters. The composition may comprise from about 0.005% to about 15%, or from about 0.05% to about 12%, or from about 0.5% to about 10%, or from about 1% to about 7%, by weight of the composition of one or more esters. Examples of suitable esters include triethyl citrate, diethyl citrate, monoethyl citrate, isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentonate, PPG myristyl propionate, diglyceryl monooleate, and diglyceryl monostearate. The composition may comprise triethyl citrate, preferably from about 1% to about 10%, or from about 4% to about 8%, all by weight of the composition.

Additional solvents include lipophilic fluids, including siloxanes, other silicones, hydrocarbons, glycol ethers, glycerin derivatives such as glycerin ethers, perfluorinated amines, perfluorinated and hydrofluoroether solvents, low-volatility nonfluorinated organic solvents, diol solvents, and mixtures thereof.

Suitable solvents listed under section 25(b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), isopropyl alcohol, and glycerin.

Preferred solvents include isopropanol, triethyl citrate, ethanol, glycerin, ethyl lactate, renewable versions thereof, and mixtures thereof. The compositions described herein may comprise a solvent selected from the group consisting of isopropanol, triethyl citrate, and mixtures thereof. In some aspects, the composition may comprise from about 1% to about 3% by weight of the composition of isopropyl alcohol. In some aspects, the composition may comprise less than about 2.5% by weight of the composition of glycerin. In some aspects, the composition is substantially free of glycerin.

### pH Adjusting Agents

The composition may comprise a buffer system. The buffer system may comprise one or more pH adjusting agents, such as an acid. The buffer system may comprise an acid (such as citric acid and/or acetic acid) and its conjugate base (such as a salt of citric acid and/or acetic acid). When the composition comprises a buffer system, the acid may be citric acid or acetic acid and the conjugate base may be a sodium salt of the respective acid.

The composition may comprise from about 0.00001% to about 5%, or from 0.01% to about 5%, or from about 0.1% to about 4%, or from about 1% to about 3.5%, by weight of the composition of a pH adjusting agent, such as a carboxylic acid or a salt thereof, e.g., citric acid or a salt thereof. In some aspects, the composition may comprise from about 0.0001% to about 3%, or from about 0.001% to about 1.5%, or from about 0.01% to about 1%, or from about 0.1% to about 0.6%, by weight of the composition of a pH adjusting agent, such as a carboxylic acid or a salt thereof, e.g., citric acid or a salt thereof. Non-limiting examples of pH adjusting agents may include malic acid, citric acid, fumaric acid, humic acid, acetic acid, monosodium citrate, sodium citrate, disodium citrate, trisodium citrate, trisodium citrate dehydrate, trisodium citrate pentahydrate, sodium acetate, or combinations thereof. The pH adjusting agent may be selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof, more preferably citric acid anhydrous or citric acid monohydrate. Preferably, the pH adjusting agent is selected from the group consisting of sodium citrate, citric acid, sodium acetate, acetic acid, and combinations thereof. Carboxylic acids, such as citric acid, or salts thereof may also function as chelants.

### Hydrotropic Salt

The composition may comprise one or more hydrotropic salts. As used herein, a hydrotropic salt is the salt of a monovalent, C5-C9 organic acid. Without wishing to be bound by theory, it is believed that a hydrotropic salt, unlike an inorganic salt, will selectively partition into and consequently modify the self-assembled surfactant microstructure. Salts with fewer than five carbon atoms, such as acetic acid, are highly water soluble and have little or no impact on the surfactant self-assembled microstructure as they reside predominantly in the water phase. Inorganic salts (e.g., salts without carbon atoms) such as sodium chloride are fully water soluble and will not partition into the surfactant self-assembled microstructure. Salts with more than nine carbon atoms may act as a co-surfactant to modify the surfactant self-assembled structure into other surfactant aggregate structures. It is believed that hydrotropic salts with five to nine carbon atoms and a monovalent organic acid moiety have sufficient balance between hydrophobicity and hydrophilicity to partition into a surfactant self-assembled microstructure and can help to create lyotropic liquid crystalline microstructures.

In some aspects, the hydrotropic salt may be a C5-C9 hydrotropic salt, preferably a C6-C7 hydrotropic salt. The organic moiety may be aliphatic or aromatic, saturated or unsaturated and linear or branched. In some aspects, the organic moiety is unsaturated and branched. The acid moiety may be a carboxylic acid or a sulfonic acid.

Examples of monovalent, C5-C9 organic carboxylic acids can include valeric acid, isovaleric acid, 2-methylbutiric acid, pivalic acid, beta-hydroxyvaleric acid, gamma-hydroxyvaleric acid, beta-hydroxy beta-methylbutyric acid, alpha-furoic acid, tetrahydrofuroic acid, caproic acid, dimethylbutanoic acid, sorbic acid, enanthic acid, cyclohexanecarboxylic acid, benzoic acid, salicylic acid, dimethylpentanoic acid, 2-ethyl-3-methylbutanoic acid, octanoic acid, methylheptanoic acid, dimethylhexanoic acid, ethanehexanoic acid, octenoic acid, nonanoic acid, and cinnamic acid. Examples of monovalent, C5-C9 organic sulfonic acids can include benzene sulfonic acid, butyl monoglycol sulfonic acid, toluene sulfonic acid, xylene sulfonic acid, and cumene sulfonic acid. Examples of suitable cations for the hydrotropic salt can include sodium, potassium, calcium, magnesium, ammonium, and combinations thereof. In some aspects, the cation may be sodium and/or potassium.

Particularly suitable hydrotropic salts can include salts of benzoic acid, salts of sorbic acid, salts of octanoic acid, and mixtures thereof. In some aspects, the hydrotropic salt may be selected from potassium benzoate, ammonium benzoate, calcium benzoate, sodium benzoate, magnesium benzoate, potassium sorbate, sodium sorbate, magnesium sorbate, ammonium sorbate, calcium sorbate, calcium octanoate, potassium octanoate, sodium octanoate, and mixtures thereof.

In some aspects, when the hydrotropic salt is a salt of benzoic acid, the composition may comprise from about 1% to about 15%, or from about 3% to about 13%, or from about 5% to about 10%, of the hydrotropic salt, all by weight of the composition. In some aspects, when the hydrotropic salt is a salt of sorbic acid, the pest control composition may comprise from about 1% to about 5%, or from about 1.5% to about 3%, or from about 2% to about 2.5%, of the hydrotropic salt.

In some aspects, it may be preferable to use a combination of hydrotropic salts such that total hydrotropic salt is from about 1% to about 6%, or from about 1.5% to about 5%, or from about 2% to about 4%, by weight of the composition. In some aspects, the composition may comprise a salt of benzoic acid and a salt of sorbic acid. When both a salt of benzoic acid and a salt of sorbic acid are used, the weight ratio of salt of benzoic acid to salt of sorbic acid may be from about 1:3 to about 3:1. It was surprisingly found that having a ratio of salt of benzoic acid to salt of sorbic acid outside of this range can lead to a microstructure that is not phase stable.

The composition may comprise a ratio of hydrotropic salt to surfactant, preferably sodium lauryl sulfate, of from about 0.15 to about 0.9, or from about 0.3 to about 0.9, or from about 0.4 to about 0.8. If the ratio of hydrotropic salt to surfactant is too high, it is believed that the hydrotropic salt will dominate the interfacial behavior and destroy the lyotropic liquid crystalline microstructure. If the ratio of hydrotropic salt is too low, it is believed that there may be insufficient influence to create a lyotropic liquid crystalline microstructure and the self-assembled microstructure will remain a surfactant aggregate, such as a micelle.

The composition may comprise a ratio of hydrotropic salt to total active ingredient of from about 0.15 to about 1.0, or from about 0.2 to about 1.0, or from about 0.3 to about 0.9.

### Test Methods

### Viscosity Test Method

Viscosity as a function of temperature and shear rate is measured using a suitable rheometer such as a Discovery HR 30 (available from TA® Instruments, New Castle, Del.) or equivalent fitted with a 40 mm stainless steel 1 degree cone and plate geometry. The rheometer with geometry is calibrated according to manufactures instructions prior to measurements. Samples are loaded, trimmed and fitted with a solvent trap to minimize evaporation. Samples are brought to within ±0.5° C. of target temperature and subsequently equilibrated at zero shear rate and ±0.5° C. of target temperature for two minutes. The sample is sheared at 1 sec⁻¹ for two minutes with viscosity data recorded every second and the viscosity at target temperature and a shear rate of 1 sec⁻¹ is the average of the last thirty data points recorded. The sample is subsequently sheared at a rate of 500 sec⁻¹ for two minutes with viscosity data collected every second and the viscosity at target temperature and a shear rate of 500 sec⁻¹ is the average of the last 30 data points recorded.

### pH Test Method

pH is measured using a standard pH meter such as, for example, a Beckman Coulter model PHI1410 pH meter equipped with a general-purpose probe (manufactured by Beckman Coulter, Brea, California, U.S.A.). The pH meter is calibrated according to the manufacturer's instructions. Measurements are performed after storing the compositions at room temperature (approximately 23° C.±2° C.) for approximately 24 hours.

### Hydrodynamic Equivalent Diameter Test Method

Dynamic light scattering (DLS) is used to measure particle size using a Malvern Zetasizer Nano ZEN3600 system (www.malvern.com) with a He-Ne laser 633 nm, or equivalent. The autocorrelation function is analyzed using the Zetasizer Software provided by Malvern Instruments, which determines the effective hydrodynamic radius, using the Stokes-Einstein equation:

$$D = \frac{{k}_{B} T}{6 πη R}$$

where, k_{B} is the Boltzmann Constant, T is the absolute temperature, η is the viscosity of the medium, and D is the mean diffusion coefficient of the scattering species, and R is the hydrodynamic radius of particles.

Particle size (i.e., hydrodynamic radius) is obtained by correlating the observed speckle pattern that arises due to Brownian motion and solving the Stokes-Einstein equation, which relates the particle size to the measured diffusion constant, as is known in the art.

The measurement angle is 173° and a refractive index of 1.46 is used for surfactant aggregate structures. The count rate for the measurement is between 200-400 kcps. All samples are kept at 25° C., unless otherwise specified.

For each sample composition, two specimen replicates are measured in this way, and the arithmetic mean of the resulting Z-average values is reported as the Hydrodynamic Equivalent Diameter in nanometers (nm) to the nearest 0.1 nm.

### Spray Droplet Size Test Method

The Spray Droplet Size Test Method is used to characterize the spray droplet size distribution of a sample product of interest. In this method, spray pattern of a sample product is characterized by using a laser diffraction particle size distribution analyzer apparatus, and multiple metrics associated with the measured diffraction-based droplet-size distribution are calculated and reported.

### Sample Preparation

Full, unused specimen bottles of the sample product of interest are used in this test. Specimen bottles are stored at 23±2° C. prior to testing and testing is performed at 23±2° C. Immediately prior to analysis, bottles may be sprayed very briefly while positioned their intended in-use orientation to ensure proper priming. At least three specimen bottles of the sample product are measured.

### Laser Diffraction Particle Size Distribution Analyzer Apparatus

A laser diffraction particle size distribution analyzer apparatus suitable for measuring liquid droplets in air is used in this analysis. A suitable exemplary apparatus is the Malvern Spraytec (Malvern Panalytical Ltd., Malvern, UK) or equivalent. Using such an instrument, a droplet spray is passed perpendicularly to and through a laser beam and scatters a portion of laser beam intensity, which is then focused onto a detector array. A combination of Fraunhofer and Mie scattering theories is used (generally through instrument software) to convert the pattern of scattered intensity to a size distribution of particles given the refractive of indices of the liquid droplets (here assumed to be that of water) and the surrounding medium (air). Suitable apparatus is capable of capturing at least 2 seconds of continuous spraying and measuring distributions at least covering the equivalent diameter range of 1 μm to 900 μm.

One suitable exemplary instrument configuration on suitable exemplary apparatus Malvern Spraytec, using the provided Malvern instrument control software to establish an “SOP,” is as follows: Hardware Configuration is set to “Default”, Measurement Type is set to “Rapid”, Data Acquisition Rate is set to “250 Hz”, and Lens Type is set to “300”. Within the Measurement menu: Background is set to “3 seconds”, Inspection is selected, the box under Output Trigger is Unchecked. Under the Measurement tab “Rapid” is selected, Events Number is set to “1”, Duration Per Event is set to “4000.0”, Units is set to “ms”. Measurement Trigger where Trigger Type is set to “Transmission drops to level” and Transmission is set to “96”, Data Collection where Start is set to “52”, Units is set to “ms”, and select “before the trigger” from the drop-down menu. On the Advanced tab window, all boxes are Unchecked, and Grouping is “no grouping”; The Background Alarms are set to “default values”. On the Analysis Tab and under Optical Properties, Particle Set is set to “Water”, Dispersant set to “Air”, Multiple Scattering Analysis is set to “Enable”. On the Data Handling tab and under Detector Range is set to “first: 1 and last: last”, “No extinction analysis” box is selected, Scattering threshold is set to “1”. On the Data Handling/Spray Profile the Path Length is set to “100.0”, the Alarm is selected, and the “Use default values” box is checked. On the Additional Properties tab the Curve Fit is set to “no fit”, User Size is set to “enable box”, the drop-down menu is set to “Default”. On the Additional Properties/Advanced tab Particle Diameter is set to “0.10” for the minimum and to “900” for the maximum, and Result Type is set to “Volume Distribution”. On the Output tab, Export Option is set to “not selected”, the Derived Parameter is selected, the Use Averaging Period box is selected and set to “0.0” and “ms”. On the Average menu “Average scatter data” is selected.

To reduce possible stray light effects, it may be advantageous to reduce ambient light in the vicinity of the laser diffraction particle size distribution analyzer apparatus through the use of black curtains or other opaque guarding installed located more immediately to the laser beam and collection optics. Additionally, air curtains may be used to keep source and collection optics clean and free of fouling from droplet spray. Finally, it may be advantageous to locate an exhaust ventilation port operating at slight negative pressure (e.g. approximately 0.3 inches of water column differential pressure) at the end of the spray path to allow spray to pass through laser beam unimpeded.

### Diffraction Measurement

Each of the individual bottle specimens of the sample product of interest is measured as follows. The specimen bottle is first positioned such that the nozzle output is 12.0±0.5 inches from the center of the beam, aimed perpendicular and toward the beam, and located such that the center of the spray impinges the laser beam. (If the bottle is of a design such that only some orientations allow for priming and fluid spray, the bottle is additionally positioned so as to enable fluid spray.)

The spray is initiated by fully depressing the spray nozzle actuator, and the instrument is triggered to begin collection of scattering data. (Typically, this triggering is automatically initiated by the instrument after detecting a slight dip in optical transmission.) Continuous spray with the spray nozzle actually fully depressed is maintained and measured for at least 2 seconds and no more than 10 seconds.

### Analysis

For each of the specimen bottles measured, a histogram size (effective diameter) distribution is calculated based on the scattering pattern observed during the spray measurement. For each specimen bottle, four parameters associated with the size distribution are calculated and reported. Considering the total volume present in the experimental size distribution, Dv10 is the diameter below which 10% of the total volume associated with the size distribution resides. Dv50 is the diameter below which 50% of the total volume associated with the size distribution resides. Dv90 is the diameter below which 90% associated with the total volume of the size distribution resides. Finally, D[3,2], the surface-area-weight mean diameter (or Sauter mean diameter) is calculated based on the observed size distribution. D[3,2] is defined as

$$D [ 3 , 2 ] = \frac{\sum {D}_{i}^{3} {n}_{i}}{\sum {D}_{i}^{2} {n}_{i}}$$

where each Dᵢ is an observed diameter in the distribution and nᵢ is the corresponding relative population of that observed diameter. For each of the specimen bottles tested, Dv10, Dv50, Dv90, and D[3,2] are calculated and recorded. The arithmetic mean of all Dv10 values among all specimen bottles measured is calculated and reported in micrometers (μm) to the nearest 0.1 μm as the Dv10 value of the sample product. The arithmetic mean of all Dv50 values among all specimen bottles measured is calculated and reported in m to the nearest 0.1 m as the Dv50 value of the sample product. The arithmetic mean of all Dv90 values among all specimen bottles measured is calculated and reported in m to the nearest 0.1 m as the Dv90 value of the sample product. The arithmetic mean of all D[3,2] values among all specimen bottles measured is calculated and reported in m to the nearest 0.1 μm as the D[3,2] value of the sample product.

### Turbidity Method

A turbidimeter is used to measure the turbidity of aqueous surfactant compositions. This instrument measures the turbidity of liquids in Nephelometric Turbidity Units (NTU). The method of measuring turbidity is described in detail in the following reference: Hach 2100Q and 2100Qis User Manual, Edition 6, August 2021, from the Hach Company. If a sample is not homogenous prior to analysis, the sample is inverted until it appears homogenous and is then poured into an analyte vile for measurement.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

### Spray Diameter Method

Spray diameter is measured using thermal sensitive paper mounted on a rigid test stand. Test samples are equilibrated to 20 to 24° C. The test can is placed perpendicular +/−100 to the paper at a distance of 12 inches. After spray is completed, the test paper is photographed and measured using a 12-inc scale over the widest dimension of the cone shape.

The average diameter among the three replicates is calculated and reported as Spray Diameter in centimeters (cm) to the nearest 0.1 cm.

### Spray Rate Method

Spray rate is determined by equilibrating a dispenser to ambient temperature (22° C.), weighing a newly filled dispenser, discharging the dispenser for 10 seconds, and weighing the dispenser a second time. Time is measured using a stopwatch and weight using a scale with an accuracy of at least 0.1 g, such as one available from Mettler-Toledo of Columbus, Ohio or equivalent. The flow rate is calculated as the weight loss (initial−final weight) divided by the 10 second discharge time. The average spray rate among three separate dispenser replicates is calculated and reported as Spray Rate to the nearest 0.1 g/s.

### Combinations

Paragraph A. An aerosol pest control product comprising an aerosol dispensing device and a pest control composition, wherein the aerosol dispensing device comprises:
i. an aerosol container comprising a reservoir containing the pest control composition and a propellant;
ii. an aerosol valve in fluid communication with the reservoir;
iii. an actuator in operative communication with the aerosol valve, and
iv. a nozzle in fluid communication with the aerosol valve and configured to atomize the pest control composition, the nozzle comprising:
v. a substantially cup-shaped nozzle insert comprising an exit orifice;
vi. a nozzle body for receiving and retaining the nozzle insert, the nozzle body in fluid communication with the aerosol valve and comprising an insert post having an end surface;
   wherein the nozzle comprises a primary swirl chamber in fluid communication with one or more inlet ports and a secondary swirl chamber disposed between the exit orifice and the primary swirl chamber, the exit orifice disposed generally concentric with the primary and secondary swirl chambers and in fluid communication therewith,
   wherein the one or more inlet ports are in fluid communication with the aerosol valve;
   wherein a centerline of the one or more inlet ports intersects a center point of the primary swirl chamber;
   wherein the secondary swirl chamber comprises a side wall extending in a decreasing taper towards the exit orifice;
   wherein the exit orifice comprises a side wall extending in an increasing taper from an entrance end adjacent the secondary swirl chamber to an opposing exit end;
   wherein the pest control composition exhibits a ratio of a first viscosity at a shear rate of 1 sec⁻¹ to a second viscosity at a shear rate of 500 sec⁻¹ measured at 22° C. of at least 1.5.

Paragraph B. The aerosol pest control product of Paragraph A, wherein the nozzle comprises at least two inlet ports.

Paragraph C. The aerosol pest control product of Paragraph B, wherein each of the at least two inlet ports comprise a centerline and wherein the centerlines are substantially equidistant apart along an outer wall of the primary swirl chamber.

Paragraph D. The aerosol pest control product of any of Paragraphs A-C, wherein the secondary swirl chamber has a first diameter and a second diameter, wherein a ratio of the first diameter to the second diameter is greater than about 1 and less than about 1.6, preferably about 1.5.

Paragraph E. The aerosol pest control product of any of Paragraphs A-D, wherein a ratio of a primary swirl chamber maximum diameter to a secondary swirl chamber maximum diameter is greater than 1.

Paragraph F. The aerosol pest control product of any of Paragraphs A-E, wherein a volume of the secondary swirl chamber is less than a volume of the primary swirl chamber.

Paragraph G. The aerosol pest control product of any of Paragraphs A-F, wherein the secondary swirl chamber comprises a side wall that forms an angle relative to a longitudinal axis of the nozzle insert of from about 20 to about 30 degrees, preferably from about 22 to about 28 degrees, more preferably from about 24 to about 27 degrees.

Paragraph H. The aerosol pest control product of any of Paragraphs A-G, wherein the exit orifice comprises a side wall that forms an angle relative to a longitudinal axis of the nozzle insert of from about 4 to about 12 degrees, preferably from about 6 to about 10 degrees.

Paragraph I. The aerosol pest control product of any of Paragraphs A-H, wherein the pest control composition has a first viscosity of from about 40 cP to about 750 cP at a shear rate of 1 sec⁻¹ measured at 22° C. and a second viscosity of from about 10 cP to about 50 cP at a shear rate of 500 sec⁻¹ measured at 22° C.

Paragraph J. The aerosol pest control product of any of Paragraphs A-I, wherein the pest control composition, upon discharge from the nozzle, exhibits at least one of the following: (a) a Dv50 value of from about 80 μm to about 200 μm as measured according to the Spray Droplet Size Test Method; (b) a spray rate of from about 3 g/s to about 6 g/s as measured according to the Spray Rate Method; and (c) a spray diameter of from about 10 cm to about 21 cm as measured according to the Spray Diameter Method.

Paragraph K. The aerosol pest control product of any of Paragraphs A-J, wherein the pest control composition comprises:
a. from about 4% to about 10% by weight of the composition of sodium lauryl sulfate;
b. a C₅ to C₉ hydrotropic salt;
c. from about 1% to about 10% by weight of the composition of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof; and
d. from about 60% to about 95% by weight of the pest control composition of water.

Paragraph L. The aerosol pest control product of any of Paragraphs A-K, wherein the secondary swirl chamber has a swirl chamber volume of from about 1.5 mm³ to about 2.5 mm³.

Paragraph M. The aerosol pest control product of any of Paragraphs A-L, wherein the nozzle insert comprises an outer surface and a cavity extending along a longitudinal axis with an end face, wherein the nozzle insert comprises grooves disposed on the end face, and wherein the one or more inlet ports are substantially defined by the end surface of the insert post and the grooves.

Paragraph N. The aerosol pest control product of any of Paragraphs A-M, wherein the insert post comprises grooves disposed on the end surface of the insert post, and wherein the one or more inlet ports are substantially defined by the grooves and an end face of the nozzle insert.

Paragraph O. The aerosol pest control product of any of Paragraphs A-N, wherein a first angle is formed between a first side of each of a first and a second inlet port and a tangent direction along an outer wall of the primary swirl chamber intersecting a leading side, wherein a second angle is formed between a second side of each of the first and second inlet ports and a tangent direction along the outer wall of the primary swirl chamber intersecting a trailing side, wherein a ratio between the first angle and the second angle is from about 1 to less than about 2.

Paragraph P. The aerosol pest control product of Paragraph B, wherein the at least two inlet ports comprise a first inlet port and a second inlet port, wherein a fluid is configured to flow from the first inlet port towards a center point of the primary swirl chamber in a first direction, wherein the fluid is configured to flow from the second inlet port towards the center of the primary swirl chamber in a second direction, wherein the first direction and the second direction are at least partially aligned and intersect within the primary swirl chamber.

Paragraph Q. A method of dispensing a pest control product from an aerosol dispensing device comprising a nozzle comprising a primary swirl chamber, a secondary swirl chamber, and one or more inlet ports, wherein a centerline of each of the one or more inlet ports intersects a center point of the primary swirl chamber, the method comprising:
a. dispensing the pest control product from the container through the one or more inlet ports and the primary and secondary swirl chambers;
wherein the pest control product exhibits a ratio of a first viscosity at a shear rate of 1 sec⁻¹ to a second viscosity at a shear rate of 500 sec⁻¹ measured at 22° C. of at least 1.5;
wherein the dispensed pest control product has a Dv50 value of from about 80 μm to about 200 μm, preferably from about 90 μm to about 180 μm, more preferably from about 100 μm to about 150 μm, as measured according to the Spray Droplet Size Test Method, and a Spray Diameter of from about 10 cm to about 21 cm, preferably from about 13 cm to about 18 cm, as measured according to the Spray Diameter Method.

Paragraph R. The method of Paragraph Q, wherein the nozzle comprises at least two inlet ports.

Paragraph S. The method of Paragraph Q or R, wherein the secondary swirl chamber comprises a side wall extending in a decreasing taper towards the exit orifice and the exit orifice comprises a side wall extending in an increasing taper from an entrance end adjacent the secondary swirl chamber to an opposing exit end.

Paragraph T. The method of any of Paragraphs Q-S, wherein a spray rate of the dispensed pest control product is from about 3 g/s to about 6 g/s, preferably from about 3.5 g/s to about 5 g/s, as measured according to the Spray Rate Method.

Paragraph U. The method of any of Paragraphs Q-T, wherein the dispensed pest control product has a D[3][2] value of from about 80 μm to about 180 μm, preferably from about 85 μm to about 150 μm, more preferably from about 90 μm to about 125 μm.

Paragraph V. The method of any of Paragraphs Q-U, wherein the at least two inlet ports comprise a first inlet port and a second inlet port, wherein a fluid is configured to flow from the first inlet port towards a center point of the swirl chamber in a first direction, wherein the fluid is configured to flow from the second inlet port towards the center of the swirl chamber in a second direction, wherein the first direction and the second direction are at least partially aligned and intersect within the swirl chamber.

Paragraph W. The method of any of Paragraphs Q-V, wherein the pest control product comprises:
a. from about 0.5% to about 12.5% by weight of the composition of sodium lauryl sulfate;
b. from about 0.5% to about 15% by weight of the composition of one or more active ingredients selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof, preferably selected from the group consisting of geraniol, cornmint oil, peppermint oil, rosemary oil, lemongrass oil, and mixtures thereof; and
c. from about 60% to about 90% by weight of the composition of water.

Paragraph X. The method of any of Paragraphs Q-W, wherein the pest control product comprises a hydrodynamic equivalent diameter of from about 10 nm to about 50 nm, preferably from about 15 nm to about 45 nm, more preferably from about 22 nm to about 40 nm.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An aerosol pest control product comprising an aerosol dispensing device and a pest control composition, wherein the aerosol dispensing device comprises:
a. an aerosol container comprising a reservoir containing the pest control composition and a propellant;
b. an aerosol valve in fluid communication with the reservoir;
c. an actuator in operative communication with the aerosol valve, and
d. a nozzle in fluid communication with the aerosol valve and configured to atomize the pest control composition, the nozzle comprising:
i. a substantially cup-shaped nozzle insert comprising an exit orifice;
ii. a nozzle body for receiving and retaining the nozzle insert, the nozzle body in fluid communication with the aerosol valve and comprising an insert post having an end surface;
wherein the nozzle comprises a primary swirl chamber in fluid communication with one or more inlet ports and a secondary swirl chamber disposed between the exit orifice and the primary swirl chamber, the exit orifice disposed generally concentric with the primary and secondary swirl chambers and in fluid communication therewith;
wherein the one or more inlet ports enter the primary swirl chamber non-tangentially, the one or more inlet ports are in fluid communication with the aerosol valve;
wherein the secondary swirl chamber has a first diameter and a second diameter, wherein a ratio of the first diameter to the second diameter is greater than about 1 and less than about 1.6;
wherein the pest control composition is non-Newtonian.

2. The aerosol pest control product of claim 1, wherein the nozzle comprises at least two inlet ports.

3. The aerosol pest control product of claim 2, wherein each of the at least two inlet ports comprise a centerline and wherein the centerlines are substantially equidistant apart along an outer wall of the primary swirl chamber.

4. The aerosol pest control product of claim 1, wherein a volume of the secondary swirl chamber is less than a volume of the primary swirl chamber.

5. The aerosol pest control product of claim 1, wherein the exit orifice comprises a side wall that forms an angle relative to a longitudinal axis of the nozzle insert of from about 4 to about 12 degrees.

6. The aerosol pest control product of claim 1, wherein the pest control composition, upon discharge from the nozzle, exhibits at least one of the following: (a) a Dv50 value of from about 80 μm to about 200 μm as measured according to the Spray Droplet Size Test Method; (b) a spray rate of from about 3 g/s to about 6 g/s as measured according to the Spray Rate Method; and (c) a spray diameter of from about 10 cm to about 21 cm as measured according to the Spray Diameter Method.

7. The aerosol pest control product of claim 1, wherein the pest control composition has a first viscosity of from about 40 cP to about 750 cP at a shear rate of 1 sec⁻¹ measured at 22° C. and a second viscosity of from about 10 cP to about 50 cP at a shear rate of 500 sec⁻¹ measured at 22° C.

8. The aerosol pest control product of claim 1, wherein the pest control composition comprises:
a. from about 4% to about 10% by weight of the composition of sodium lauryl sulfate;
b. a C5 to C9 hydrotropic salt;
c. from about 1% to about 10% by weight of the composition of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof; and
d. from about 60% to about 95% by weight of the pest control composition of water.

9. An aerosol pest control product comprising an aerosol dispensing device and a pest control composition, wherein the aerosol dispensing device comprises:
a. an aerosol container comprising a reservoir containing the pest control composition and a propellant;
b. an aerosol valve in fluid communication with the reservoir;
c. an actuator in operative communication with the aerosol valve, and
d. a nozzle in fluid communication with the aerosol valve and configured to atomize the pest control composition, the nozzle comprising:
i. a substantially cup-shaped nozzle insert comprising an exit orifice;
ii. a nozzle body for receiving and retaining the nozzle insert, the nozzle body in fluid communication with the aerosol valve and comprising an insert post having an end surface;
wherein the nozzle comprises a primary swirl chamber in fluid communication with one or more inlet ports and a secondary swirl chamber disposed between the exit orifice and the primary swirl chamber, the exit orifice disposed generally concentric with the primary and secondary swirl chambers and in fluid communication therewith;
wherein the one or more inlet ports are in fluid communication with the aerosol valve;
wherein a centerline of the one or more inlet ports intersects a center point of the primary swirl chamber;
wherein the secondary swirl chamber comprises a side wall extending in a decreasing taper towards the exit orifice;
wherein the exit orifice comprises a side wall extending in an increasing taper from an entrance end adjacent the secondary swirl chamber to an opposing exit end;
wherein the pest control composition exhibits a ratio of a first viscosity at a shear rate of 1 sec⁻¹ to a second viscosity at a shear rate of 500 sec⁻¹ measured at 22° C. of at least 1.5.

10. The aerosol pest control product of claim 9, wherein, upon discharge from the nozzle, the pest control composition exhibits a Dv50 value of from about 80 μm to about 200 μm as measured according to the Spray Droplet Size Test Method.

11. The aerosol pest control product of claim 10, wherein, upon discharge from the nozzle, the pest control composition exhibits a spray diameter of from about 10 cm to about 21 cm as measured according to the Spray Diameter Method.

12. The aerosol pest control product of claim 9, wherein a ratio of a primary swirl chamber maximum diameter to a secondary swirl chamber maximum diameter is greater than 1.

13. The aerosol pest control product of claim 9, wherein the secondary swirl chamber comprises a side wall that forms an angle relative to a longitudinal axis of the nozzle insert of from about 20 to about 30 degrees.

14. An aerosol pest control product comprising an aerosol dispensing device and a pest control composition, wherein the aerosol dispensing device comprises:
a. an aerosol container comprising a reservoir containing the pest control composition and a propellant;
b. an aerosol valve in fluid communication with the reservoir;
c. an actuator in operative communication with the aerosol valve, and
d. a nozzle in fluid communication with the aerosol valve and configured to atomize the pest control composition, the nozzle comprising:
i. a substantially cup-shaped nozzle insert having an exit orifice;
ii. a nozzle body for receiving and retaining the nozzle insert, the nozzle body in fluid communication with the aerosol valve and comprising an insert post having an end surface;
wherein the nozzle comprises a primary swirl chamber in fluid communication with at least two opposing inlet ports and a secondary swirl chamber disposed between the exit orifice and the first chamber, the exit orifice disposed generally concentric with the primary and secondary swirl chambers and in fluid communication therewith;
wherein the at least two inlet ports comprise a first inlet port and a second inlet port, the first and second inlet ports are in fluid communication with the aerosol valve;
wherein a fluid is configured to flow from the first inlet port towards a center point of the primary swirl chamber in a first direction, wherein the fluid is configured to flow from the second inlet port towards the center of the primary swirl chamber in a second direction, wherein the first direction and the second direction are at least partially aligned and intersect within the primary swirl chamber;
wherein, upon discharge from the nozzle, the pest control composition exhibits a Dv50 value of from about 80 μm to about 200 μm as measured according to the Spray Droplet Size Test Method;
wherein the pest control composition is non-Newtonian.

15. The aerosol pest control product of claim 14, wherein a spray rate of the pest control composition discharged from the nozzle is in the range of from about 3 g/s to about 6 g/s as measured according to the Spray Rate Method.

16. The aerosol pest control product of claim 14, wherein the secondary swirl chamber has a first diameter and a second diameter, wherein a ratio of the first diameter to the second diameter is greater than about 1 and less than about 1.6.

17. The aerosol pest control product of claim 16, wherein the exit orifice comprises a side wall, wherein the side wall continuously tapers from an entrance end adjacent the secondary swirl chamber to an opposing exit end, wherein the diameter increases from the entrance end to the exit end.

18. The aerosol pest control product of claim 14, wherein a ratio of a primary swirl chamber maximum diameter to a secondary swirl chamber maximum diameter is greater than 1.

19. The aerosol pest control product of claim 14, wherein the pest control composition has a first viscosity of from about 40 cP to about 750 cP at a shear rate of 1 sec⁻¹ measured at 22° C. and a second viscosity of from about 10 cP to about 50 cP at a shear rate of 500 sec⁻¹ measured at 22° C.

20. The aerosol pest control product of claim 14, wherein, upon discharge from the nozzle, the pest control composition exhibits a spray diameter of from about 10 cm to about 21 cm as measured according to the Spray Diameter Method.
